(19) United States
(12) Patent Application Publication
(10) Pub. No.: US 2019/0185620 A1
(43) Pub. Date: Jun. 20, 2019

(54) SURFACE-MODIFIED POLYMERS

(71) Applicant: North Carolina State University, Raleigh, NC (US)

(72) Inventors: Christopher B. Gorman, Cary, NC (US); Lance Wilson, Stamford, CT (US); Gilbert A. Castillo, Raleigh, NC (US); Jan Genzer, Raleigh, NC (US); Michael D. Dickey, Raleigh, NC (US); Kirill Efimenko, Apex, NC (US)

(21) Appl. No.: 16/324,772

(22) PCT Filed: Aug. 12, 2016
(86) PCT No.: PCT/US16/46860

§ 371 Date: Feb. 11, 2019

(51) Int. Cl. C08G 63/91

(52) U.S. Cl. CPC C08G 63/916

(57) ABSTRACT

Surface-modified polymer compositions are provided. The surface-modified polymer compositions can include a polymer and a multifunctional linker. The surface-modified polymer compositions can include a polymer, a multifunctional linker, and a surface group. Aqueous-based processes can be used to fabricate the surface-modified polymer compositions.

### TECHNICAL FIELD

The present disclosure relates to surface-modified polymers, methods of preparing and using surface-modified polymers, and articles including surface-modified polymers.

### BACKGROUND

Polymers are useful in a variety of applications, including fundamental research, drug delivery, biomaterials, disposable beverage bottles, food packaging, textiles, adhesives, tissue scaffolds, medical implants, flexible displays, filters, protective coatings, friction and wear, microelectronic devices, thin-film technology, composites, and many other areas. There exists a need for improved polymeric materials and methods of making the same.

### SUMMARY

In one aspect, disclosed are surface-modified polymer compositions, including (a) a polymer; and (b) a multifunctional surface-modifier covalently bonded to the polymer. The polymer may be substantially free of solvent-induced crystallization or plasticization.

In another aspect, disclosed are methods of preparing surface-modified polymer compositions. The methods may include reacting a polymer with a multifunctional surface-modifier in aqueous solution.

In another aspect, disclosed are surface-modified polymer compositions, including (a) a polymer; (b) a multifunctional linker; and (c) a surface group. The multifunctional linker may be covalently bonded to the polymer and to the surface group, thereby linking the surface group to the polymer. The polymer may be substantially free of solvent-induced crystallization or plasticization.

In another aspect, disclosed are methods of preparing surface-modified polymer compositions. The methods may include reacting a polymer with a multifunctional linker in aqueous solution to provide a first surface-modified polymer; hydrolyzing one or more functional groups of the first surface-modified polymer to provide a second surface-modified polymer; and reacting the second surface-modified polymer with a surface-modifier to provide a third surface-modified polymer.

### BRIEF DESCRIPTION OF THE DRAWINGS

FIG. 1 is a graph showing how the resulting thickness of the PET layer correlates with the spin-speed and PET concentration in solution.

FIG. 2 illustrates the reaction of methyl toluate PET analogue with a small chain primary amine to generate the amide under various solvent conditions.

FIG. 3 shows on top, the ¹H-NMR and on bottom, the mass spectra of toluoylmethylester, toluoylmethylamide, and toluoylpropylamide.

FIG. 4 shows ATR-FTIR spectra of toluoylmethylester (left column) and PET (right column) that have been modified with small molecule amines. (left column, from top to bottom): (A) methyltoluate (black), (B) N,4-dimethylbenzamide (red), (C) 4-methyl-N-propylbenzamide (blue). (right column, from top to bottom): (D) PET (black), (E) PET treated with aqueous methyl amine(red), (F) PET containing propylamide groups (blue). The shaded areas in the insets denote the expected locations for amide I, amide II, and amide III bands.

FIG. 5 shows ATR-FTIR spectra of gold coated glass slides with (A) spun-cast PET (black), (B) PET treated with 1 w/w % aqueous methylamine (red), (C) PET treated with 1 w/w % aqueous APTES (blue), and (D) PET treated with 20 w/w % aqueous methylamine (green). The shaded areas in the insets denote the expected locations for amide I, amide II, and amide III bands.

FIG. 6 shows AFM images of virgin PET (A) and APTES treated PET (B).

FIG. 7 shows XPS survey spectra of a) PET at 900 take-off angle, b) APTES treated PET at 900 take-off angle, c) PET at 150 take-off angle, d) APTES treated PET at 150 take-off angle.

FIG. 8 shows high resolution XPS spectra of PET (A & C, black) and PET/APTES (B & D, red) collected at α=90° (top panel) and α=15° (bottom panel) take-off angles. The spectra feature the O is region (527-539 eV), N is region (394-405 eV), C is region (281-293 eV), and Si 2p region (95-107 eV). At α=90°, d≈9 nm and at α=150, d≈3 nm.

FIG. 9 shows ToF-SIMS images of C₇H₄O₂— PET fragment, CN⁻ and CNO⁻ fragments corresponding to APTES.

FIG. 10 shows a histogram of the ToF-SIMS images' pixel intensities of (A) C7H4O2- PET fragment, (B) CN- and (C) CNO-fragments corresponding to APTES.

FIG. 11 shows AFM images of PET exposed to perfluorosilane (C) and PET-APTES exposed to perfluorosilane vapor (D).

FIG. 12 shows survey XPS spectra (left) and XPS fluorine XPS (˜689 eV) spectra (right) of silica (black), untreated PET (red), and APTES treated PET (blue) exposed to perfluorodecyldimethylchlorosilane vapor.

FIG. 13 shows ToF-SIMS images of F⁻ fragment of PET (top left), PET exposed to perfluorosilane vapor (top right), PET-APTES (bottom left), PET-APTEs exposed to perfluorosilane vapor (bottom left).

FIG. 14 shows a histogram of the ToF-SIMS image's pixel intensities for the F-fragment in PET prior and after treatment with perfluorosilane vapor on untreated and APTES treated PET films.

FIG. 15 shows FTIR-ATR spectra of silicate film.

FIG. 16 shows on the left, an AFM image of the silicate layer on the silicate wafer and on the right, an AFM image of the silicate layer on the PET-APTES substrate.

FIG. 17 shows an image of delaminated silicate film on virgin PET substrate.

FIG. 18 shows ToF-SIMS images of C₇H₄O₂⁻ on virgin PET, PET-APTES, and PET-APTES covered by silicate.

FIG. 19 shows XPS spectra of the silicate film at a) 90° take-off angle and b) 15° take-off angle.

FIG. 20 shows images for spin-coated PET on silicon wafer (left), spin-coated PET on silicon wafer exposed to THF for 60 seconds (middle), and spin-coated PET on silicon wafer, treated with APTES, followed by spin on glass after exposure to THF for 1 hour (right). Insets are 100×100 um optical microscopy images.

FIG. 21 shows water contact angles for spin-coated PET on silicon wafer (left), spin-coated PET on silicon, treated with APTES, followed by spin on glass (middle), and spin-coated PET on silicon, treated with APTES, followed by spin on glass, and then solution deposited layer of methyltrichlorosilane.

FIG. 22 shows optical microscopy images of sodium silicate coating on PET substrate (top row) and virgin PET (bottom row).

FIG. 23 shows the UV/Vis % transmittance spectra of virgin PET and sodium silicate coated PET.

### DETAILED DESCRIPTION

Many polymers possess strong mechanical and optical properties, but do not have the desired surface properties required by a number of industrial applications that benefit from engineered surface properties. For example, polyethylene terephthalate possesses a relatively low surface energy, and often does not have the desired surface properties required by a number of industrial applications. Examples include adhesives, tissue scaffolds, medical implants, flexible displays, filters, protective coatings, friction and wear, microelectronic devices, thin-film technology, and composites.

The surface of polymers can be modified to alter surface energy, improve chemical inertness, induce surface cross-linking, increase or decrease surface roughness and hardness, enhance surface lubricity and electrical conductivity, impart functional groups at the surface for specific interactions with other functional groups, provide for biocompatibility, provide for non-stick, increase or decrease scratch resistance, increase or decrease wettability, or provide anti-fouling properties. Addition of reactive functional groups to polymer surfaces can serve as a means of generating anchoring points for grafting materials onto the polymer surface, which can be utilized to further tune its surface characteristics.

Commonly used surface modification/coating techniques include plasma deposition, physical vapor deposition, chemical vapor deposition, ion bombardment, ion-beam sputter deposition, ion-beam-assisted deposition, sputtering, thermal spraying, and dipping. Conventional permanent bonding of a surface modifying compound to a polymer generally requires activation of the substrate surface (e.g., introducing a reactive functional group on the substrate surface). Activation of polymers can occur through a multitude of different treatments (e.g., high energy radiation, plasma, and corona treatment). After a reactive functional group is introduced on the substrate surface, it is reacted with a surface modifying compound. Alternatively, the activated surface is reacted with a chemical linker moiety which serves as a linker between the substrate surface and surface modifying compound.

Many of these modifications, however, lead to degradation of the polymer chains at the surface. For example, many linkers and solvents used in these processes are not compatible with a vast range of polymeric materials. Many organic solvents cause depression of the glass transition temperature (T_{g}) of polymers and this limits the range of solvents that can be used to modify polymer surfaces. Also, many surface activation processes are costly, time-consuming, and can result in activation of only a small portion of the polymer surface. By way of example, copolyester will undergo solvent-induced crystallization when exposed to most aprotic polar and nonpolar solvents during surface-modification via transamidation, altering its mechanical and optical properties. Furthermore, such transamidation reactions proceed unacceptably slowly or are the result of physisorption rather than chemisorption (e.g., the ester-to-amide bond formation proceeds very slowly or not at all in many polar and non-polar solvents, such as tetrahydrofuran, toluene, methanol, and ethanol). Accordingly, there is a need for processes of producing surface-modified polymers that are fast, low-cost, uniform across the polymer, and easily accessible.

The present disclosure provides a water-based chemical reaction to facilitate modification of surfaces of polymers. Water is a desirable solvent since it is environmentally benign. Further, water is a poor solvent for many polymers of interest (e.g., polyethylene terephthalate) and therefore may not dissolve the polymers nor change their surface morphology due to plasticization and solvent-induced crystallization. The present disclosure demonstrates that not only can polymers be surface modified in dilute aqueous solutions, but also that this reaction can proceed far more rapidly in water than in other, polar solvents, such as alcohols. Functionalization in water may be sufficiently rapid so as to be useful for commercial applications. The modified surface of the polymers provided by the present disclosure can be used to functionalize and change the chemical/physical properties of polymers without affecting morphology or structural integrity.

In exemplary embodiments, polyesters can be surface-modified with water-soluble, multifunctional molecules containing at least one primary amine. For example, polyethylene terephthalate can be surface-amidated using (3-aminopropyl)triethoxysilane (APTES). The transamidation reaction can occur at a fast rate (e.g., minutes to hours). After amidation, the polymer may have silanol groups exposed on the surface, which can be further functionalized to change the surface property depending on the desired application. For example, deposition of a silica-like layer can be accomplished via a sol-gel method to significantly increase the surface density of hydroxyl groups, for example if a wettable surface is desired. Thin silicate layers also have the potential to impart high solvent resistance to polyester surfaces, and increase the barrier properties of polyester films.

### 1. Definitions

Unless otherwise defined, all technical and scientific terms used herein have the same meaning as commonly understood by one of ordinary skill in the art. In case of conflict, the present document, including definitions, will control. Preferred methods and materials are described below, although methods and materials similar or equivalent to those described herein can be used in practice or testing of the present invention. All publications, patent applications, patents and other references mentioned herein are incorporated by reference in their entirety. The materials, methods, and examples disclosed herein are illustrative only and not intended to be limiting.

The terms “comprise(s),” “include(s),” “having,” “has,” “can,” “contain(s),” and variants thereof, as used herein, are intended to be open-ended transitional phrases, terms, or words that do not preclude the possibility of additional acts or structures. The singular forms “a,” “an” and “the” include plural references unless the context clearly dictates otherwise. The present disclosure also contemplates other embodiments “comprising,” “consisting of” and “consisting essentially of,” the embodiments or elements presented herein, whether explicitly set forth or not.

The conjunctive term “or” includes any and all combinations of one or more listed elements associated by the conjunctive term. For example, the phrase “an apparatus comprising A or B” may refer to an apparatus including A where B is not present, an apparatus including B where A is not present, or an apparatus where both A and B are present. The phrases “at least one of A, B, . . . and N” or “at least one of A, B, . . . N, or combinations thereof” are defined in the broadest sense to mean one or more elements selected from the group comprising A, B, . . . and N, that is to say, any combination of one or more of the elements A, B, . . . or N including any one element alone or in combination with one or more of the other elements which may also include, in combination, additional elements not listed.

The modifier “about” used in connection with a quantity is inclusive of the stated value and has the meaning dictated by the context (for example, it includes at least the degree of error associated with the measurement of the particular quantity). The modifier “about” should also be considered as disclosing the range defined by the absolute values of the two endpoints. For example, the expression “from about 2 to about 4” also discloses the range “from 2 to 4.” The term “about” may refer to plus or minus 10% of the indicated number. For example, “about 10%” may indicate a range of 9% to 11%, and “about 1” may mean from 0.9-1.1. Other meanings of “about” may be apparent from the context, such as rounding off, so, for example “about 1” may also mean from 0.5 to 1.4.

The term “alkyl” as used herein, means a straight or branched, saturated hydrocarbon chain containing from 1 to 30 carbon atoms. The term “lower alkyl” or “C₁-C₆ alkyl” means a straight or branched chain hydrocarbon containing from 1 to 6 carbon atoms. The term “C₃-C₇ branched alkyl” means a branched chain hydrocarbon containing from 3 to 7 carbon atoms. The term “C₁-C₄ alkyl” means a straight or branched chain hydrocarbon containing from 1 to 4 carbon atoms. The term “C₆-C₃₀ alkyl” means a straight or branched chain hydrocarbon containing from 6 to 30 carbon atoms. The term “C₁₂-C₁₈ alkyl” means a straight or branched chain hydrocarbon containing from 12 to 18 carbon atoms. Representative examples of alkyl include, but are not limited to, methyl, ethyl, n-propyl, iso-propyl, n-butyl, sec-butyl, iso-butyl, tert-butyl, n-pentyl, isopentyl, neopentyl, n-hexyl, 3-methylhexyl, 2,2-dimethylpentyl, 2,3-dimethylpentyl, n-heptyl, n-octyl, n-nonyl, n-decyl and n-dodecyl.

The term “alkenyl” as used herein, means a straight or branched, unsaturated hydrocarbon chain containing at least one carbon-carbon double bond and from 2 to 30 carbon atoms. The term “lower alkenyl” or “C₂-C₆ alkenyl” means a straight or branched chain hydrocarbon containing at least one carbon-carbon double bond and from 1 to 6 carbon atoms. The term “C₆-C₃₀ alkenyl” means a straight or branched chain hydrocarbon containing at least one carbon-carbon double bond and from 6 to 30 carbon atoms. The term “C₁₂-C₁₈ alkenyl” means a straight or branched chain hydrocarbon containing at least one carbon-carbon double bond and from 12 to 18 carbon atoms. The alkenyl groups, as used herein, may have 1, 2, 3, 4, or 5 carbon-carbon double bonds. The carbon-carbon double bonds may be cis or trans isomers.

The term “acrylate” as used herein, refers to an α,β-unsaturated ester or acid functionality (e.g., H₂═CHC(O)—O—).

The term “alkacrylate” as used herein, refers to an alkyl substituted α,β-unsaturated ester or acid functionality (e.g., H₂═CRC(O)—O—, wherein R is an alkyl group).

The term “acrylatealkyl” as used herein, means an acrylate group, as defined herein, appended to the parent molecular moiety through an alkyl group, as defined herein.

The term “alkacrylatealkyl” as used herein, means an alkacrylate group, as defined herein, appended to the parent molecular moiety through an alkyl group, as defined herein.

The term “alkoxy” as used herein, means an alkyl group, as defined herein, appended to the parent molecular moiety through an oxygen atom.

The term “alkoxyalkyl” as used herein, means an alkoxy group, as defined herein, appended to the parent molecular moiety through an alkyl group, as defined herein.

The term “alkylcarbonyl” as used herein, means an alkyl group, as defined herein, appended to the parent molecular moiety through a carbonyl.

The term “alkylcarboxyl” as used herein, means an alkyl group, as defined herein, appended to the parent molecular moiety through a carboxyl group.

The term “amino” as used herein, means —NH₂.

The term “aryl” as used herein, means a phenyl group, or a bicyclic fused ring system. Bicyclic fused ring systems are exemplified by a phenyl group appended to the parent molecular moiety and fused to a cycloalkyl group, a phenyl group, or a heterocycle, as defined herein. Representative examples of aryl include, but are not limited to, naphthyl, phenyl, and tetrahydroquinolinyl.

The term “arylalkyl” as used herein, means an aryl group, as defined herein, appended to the parent molecular moiety through an alkyl group, as defined herein.

The term “carboxyl” as used herein, means a carboxylic acid group, or C(O)O—.

The term “cycloalkyl” as used herein, means a carbocyclic ring system containing three to ten carbon atoms, zero heteroatoms and zero double bonds. Representative examples of cycloalkyl include, but are not limited to, cyclopropyl, cyclobutyl, cyclopentyl, cyclohexyl, cycloheptyl, cyclooctyl, cyclononyl and cyclodecyl.

The term “epoxyalkyl” as used herein, means an epoxy group appended to the parent molecular moiety through an alkyl group, as defined herein.

The term “epoxyalkoxyalkyl” as used herein, means an epoxy group, appended to the parent molecular moiety through an alkoxyalkyl group, as defined herein.

The term “halogen” as used herein, means —F, —Cl, —Br, or —I.

The term “haloalkyl” as used herein, means an alkyl group, as defined herein, in which one, two, three, four, five, six, seven or eight hydrogen atoms are replaced by a halogen.

The term “heteroalkyl” as used herein, means an alkyl group, as defined herein, in which one or more of the carbon atoms has been replaced by a heteroatom selected from Si, S, O, P and N. The heteroatom may be oxidized. Representative examples of heteroalkyls include, but are not limited to, alkyl ethers, secondary and tertiary alkyl amines, amides, and alkyl sulfides.

The term “heteroaryl” as used herein, refers to an aromatic monocyclic ring or an aromatic bicyclic ring system. The aromatic monocyclic rings are five or six membered rings containing at least one heteroatom independently selected from the group consisting of N, O and S (e.g., 1, 2, 3, or 4 heteroatoms independently selected from O, S, and N). The five membered aromatic monocyclic rings have two double bonds and the six membered aromatic monocyclic rings have three double bonds. The bicyclic heteroaryl groups are exemplified by a monocyclic heteroaryl ring appended to the parent molecular moiety and fused to a monocyclic cycloalkyl group, as defined herein, a monocyclic aryl group, as defined herein, a monocyclic heteroaryl group, as defined herein, or a monocyclic heterocycle, as defined herein. Representative examples of heteroaryl include, but are not limited to, indolyl, pyridinyl (including pyridin-2-yl, pyridin-3-yl, pyridin-4-yl), pyrimidinyl, thiazolyl, and quinolinyl.

The term “heterocycle” or “heterocyclic” as used herein, means a monocyclic heterocycle, a bicyclic heterocycle, or a tricyclic heterocycle. The monocyclic heterocycle is a three-, four-, five-, six-, seven-, or eight-membered ring containing at least one heteroatom independently selected from the group consisting of O, N, and S. The three- or four-membered ring contains zero or one double bond, and one heteroatom selected from the group consisting of O, N, and S. The five-membered ring contains zero or one double bond and one, two or three heteroatoms selected from the group consisting of O, N and S. The six-membered ring contains zero, one or two double bonds and one, two, or three heteroatoms selected from the group consisting of O, N, and S. The seven- and eight-membered rings contains zero, one, two, or three double bonds and one, two, or three heteroatoms selected from the group consisting of O, N, and S. Representative examples of monocyclic heterocycles include, but are not limited to, azetidinyl, azepanyl, aziridinyl, diazepanyl, 1,3-dioxanyl, 1,3-dioxolanyl, 1,3-dithiolanyl, 1,3-dithianyl, isocyanurate, imidazolinyl, imidazolidinyl, isothiazolinyl, isothiazolidinyl, isoxazolinyl, isoxazolidinyl, morpholinyl, oxadiazolinyl, oxadiazolidinyl, oxazolinyl, oxazolidinyl, oxetanyl, piperazinyl, piperidinyl, pyranyl, pyrazolinyl, pyrazolidinyl, pyrrolinyl, pyrrolidinyl, tetrahydrofuranyl, tetrahydropyranyl, tetrahydropyridinyl, tetrahydrothienyl, thiadiazolinyl, thiadiazolidinyl, 1,2-thiazinanyl, 1,3-thiazinanyl, thiazolinyl, thiazolidinyl, thiomorpholinyl, 1,1-dioxidothiomorpholinyl (thiomorpholine sulfone), thiopyranyl, and trithianyl. The bicyclic heterocycle is a monocyclic heterocycle fused to a phenyl group, or a monocyclic heterocycle fused to a monocyclic cycloalkyl, or a monocyclic heterocycle fused to a monocyclic cycloalkenyl, or a monocyclic heterocycle fused to a monocyclic heterocycle, or a spiro heterocycle group, or a bridged monocyclic heterocycle ring system in which two non-adjacent atoms of the ring are linked by an alkylene bridge of 1, 2, 3, or 4 carbon atoms, or an alkenylene bridge of two, three, or four carbon atoms. Representative examples of bicyclic heterocycles include, but are not limited to, benzopyranyl, benzothiopyranyl, chromanyl, 2,3-dihydrobenzofuranyl, 2,3-dihydrobenzothienyl, 2,3-dihydroisoquinoline, 2-azaspiro[3.3]heptan-2-yl, azabicyclo[2.2.1]heptyl (including 2-azabicyclo[2.2.1]hept-2-yl), 2,3-dihydro-1H-indolyl, isoindolinyl, octahydrocyclopenta[c]pyrrolyl, octahydropyrrolopyridinyl, and tetrahydroisoquinolinyl. Tricyclic heterocycles are exemplified by a bicyclic heterocycle fused to a phenyl group, or a bicyclic heterocycle fused to a monocyclic cycloalkyl, or a bicyclic heterocycle fused to a monocyclic cycloalkenyl, or a bicyclic heterocycle fused to a monocyclic heterocycle, or a bicyclic heterocycle in which two non-adjacent atoms of the bicyclic ring are linked by an alkylene bridge of 1, 2, 3, or 4 carbon atoms, or an alkenylene bridge of two, three, or four carbon atoms. Examples of tricyclic heterocycles include, but are not limited to, octahydro-2,5-epoxypentalene, hexahydro-2H-2,5-methanocyclopenta[b]furan, hexahydro-1H-1,4-methanocyclopenta[c]furan, aza-adamantane (1-azatricyclo[3.3.1.1^{3,7}]decane), and oxa-adamantane (2-oxatricyclo[3.3.1.1^{3,7}]decane). The monocyclic, bicyclic, and tricyclic heterocycles are connected to the parent molecular moiety through any carbon atom or any nitrogen atom contained within the rings, and can be unsubstituted or substituted.

The term “heterocyclealkyl” as used herein, means a heterocycle, as defined herein, appended to the parent molecular moiety through an alkyl group, as defined herein.

The term “hydroxyl” as used herein, means —OH.

The term “hydroxyalkyl” as used herein, means a hydroxyl group (—OH), appended to the parent molecular moiety through an alkyl group, as defined herein.

The term “silyloxyalkyl” as used herein, means a silyloxy group [—Si(OR)₃, wherein R is alkyl or hydrogen], appended to the parent molecular moiety through an alkyl group, as defined herein.

The term “thioalkyl” as used herein, means a thiol group (—SH), appended to the parent molecular moiety through an alkyl group, as defined herein.

The term “substituted” refers to a group that may be further substituted with one or more non-hydrogen substituent groups. Substituent groups include, but are not limited to, halogen, ═O, ═S, cyano, nitro, fluoroalkyl, alkoxyfluoroalkyl, fluoroalkoxy, alkyl, alkenyl, alkynyl, haloalkyl, haloalkoxy, heteroalkyl, cycloalkyl, cycloalkenyl, aryl, heteroaryl, heterocycle, cycloalkylalkyl, heteroarylalkyl, arylalkyl, hydroxy, hydroxyalkyl, alkoxy, alkoxyalkyl, alkylene, aryloxy, phenoxy, benzyloxy, amino, alkylamino, acylamino, aminoalkyl, arylamino, sulfonylamino, sulfinylamino, sulfonyl, alkylsulfonyl, arylsulfonyl, aminosulfonyl, sulfinyl, —COOH, ketone, amide, carbamate, and acyl.

For the recitation of numeric ranges herein, each intervening number there between with the same degree of precision is explicitly contemplated. For example, for the range of 6-9, the numbers 7 and 8 are contemplated in addition to 6 and 9, and for the range 6.0-7.0, the number 6.0, 6.1, 6.2, 6.3, 6.4, 6.5, 6.6, 6.7, 6.8, 6.9, and 7.0 are explicitly contemplated.

### 2. Surface-Modified Polymers

In one aspect, disclosed are compositions of surface-modified polymers. The surface-modified polymers may retain the physical properties inherent to the polymer, but also have properties of a surface agent, without the base polymer undergoing any morphological changes (e.g., free of solvent-induced crystallization, or plasticization). This allows the surface-modified polymers to be modified and used in a variety of applications, including fundamental research, drug delivery, biomaterials, disposable beverage bottles, food packaging, textiles, adhesives, tissue scaffolds, medical implants, flexible displays, filters, protective coatings, friction and wear, microelectronic devices, thin-film technology, composites, and many other areas.

In certain embodiments, the surface-modified polymer compositions include (a) a polymer; and (b) a multifunctional surface-modifier covalently bonded to the polymer. In certain embodiments, the surface-modified polymer compositions include a plurality of multifunctional surface-modifiers.

In certain embodiments, the surface-modified polymer comprises groups of the formula:

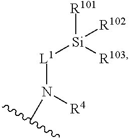

wherein R¹⁰¹, R¹⁰², and R¹⁰³, at each occurrence, are each independently selected from the group consisting of hydrogen, halogen (e.g., chloro), hydroxy, optionally substituted C₁-C₆-alkoxy, and optionally substituted aryloxy; R⁴ at each occurrence is hydrogen or C₁-C₆-alkyl; L¹ at each occurrence is C₁-C₁₀-alkylene. In certain embodiments, R¹⁰¹, R¹⁰², and R¹⁰³ are each methoxy or ethoxy. In certain embodiments, L¹ is C₃-alkylene and R⁴ is hydrogen.

In certain embodiments, the surface-modified polymer compositions include a plurality of multifunctional surface-modifiers derived from an aminofunctional alkoxysilane, wherein each multifunctional surface-modifier links to the polymer through individual amide linkages (e.g., that have formed from reaction between the amine functionality of the multifunctional surface-modifiers and ester or amide bonds of the starting polymer). For example, in certain embodiments, the surface-modified polymer comprises groups of the formula:

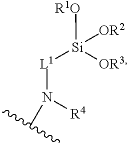

wherein R¹, R², and R³, at each occurrence, are each independently selected from the group consisting of hydrogen, optionally substituted C₁-C₆-alkyl, and optionally substituted aryl; R⁴ at each occurrence is hydrogen or C₁-C₆-alkyl; L¹ at each occurrence is C₁-C₁₀-alkylene. In certain embodiments, R¹, R², and R³ are each methyl or ethyl. In certain embodiments, R¹, R², and R³ are each hydrogen. In certain embodiments, L¹ is C₃-alkylene and R⁴ is hydrogen.

In certain embodiments, the surface-modified polymer comprises groups of the formula:

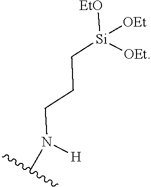 [SMILES: *NCCC[Si](OCC)(OCC)OCC]

In certain embodiments, the surface-modified polymer comprises groups of the formula:

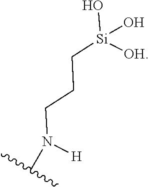 [SMILES: *NCCC[Si](O)(O)O]

The polymer covalently modified with multifunctional surface-modifier (e.g., APTES) can have a uniform topography, as measured by atomic force microscopy imaging. In certain embodiments, this composition includes a surface uniformly covered with the multifunctional surface-modifier, as measured by time of flight secondary ion mass spectrometry. In certain embodiments, the multifunctional surface-modifier has a thickness between 0.3 nm and 5 nm, or 0.4 nm and 4 nm, 0.5 nm and 3 nm, 0.6 nm and 2 nm, or 0.7 nm and 1 nm, as measured by variable angle spectroscopic ellipsometry.

In certain embodiments, the surface-modified polymer compositions comprise (a) a polymer; (b) a multifunctional linker; and (c) a surface group. The multifunctional linker can be covalently bonded to the polymer and to the surface group, linking the surface group to the polymer. The polymer may be substantially free of solvent-induced crystallization or plasticization, for example, as the result of an aqueous-based process used to prepare the surface-modified polymer composition.

In certain embodiments, the surface-modified polymer compositions comprise groups of the formula:

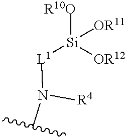

wherein R⁴ at each occurrence is independently hydrogen or C₁-C₆-alkyl; L¹ at each occurrence is independently selected from a C₁-C₁₀-alkylene; R¹⁰, R¹¹, and R¹², at each occurrence, are each independently selected from the group consisting of hydrogen, optionally substituted C₁-C₆-alkyl, optionally substituted aryl, and a surface group, provided that at least one of R¹⁰, R¹¹, and R¹² is a surface group. In certain embodiments, the surface group is derived from a tetramethyl orthosilicate, a tetraethyl orthosilicate, a tetraisopropyl orthosilicate, a tetrabutyl orthosilicate, a tetrapropoxysilane, or a sodium silicate. In certain embodiments, the surface group is derived from a compound having formula Si(OR)₄ wherein R, at each occurrence, is independently selected from the group consisting of optionally substituted alkyl and optionally substituted aryl. In certain embodiments, the surface group is derived from fluorodecyltrichlorosilane, undecenyltrichlorosilane, vinyl-trichlorosilane, decyltrichlorosilane, octadecyltrichlorosilane, dimethyldichlorosilane, decenyltrichlorosilane, fluoro-tetrahydrooctyl trimethylchlorosilane, perfluorooctyldimethylchlorosilane, fluoropropylmethyldichlorosilane, perfluorodecyldimethylchlorosilane, or 1H,1H,2H,2H-perfluorodecyldimethylchlorosilane. In certain embodiments, the surface group is derived from a biological material. Exemplary biological materials include, but are not limited to, oligonucleotides (e.g., DNA, RNA), proteins, peptides, and antibodies.

In certain embodiments, the surface-modified polymer compositions comprise groups of the formula:

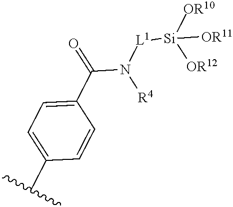

wherein R⁴, R¹⁰, R¹¹, R¹², and L¹ are as defined above. In certain embodiments, R⁴ is hydrogen at each occurrence, and L¹ is C₃-alkylene at each occurrence.

In certain embodiments, the surface-modified polymer compositions comprise groups of the formula:

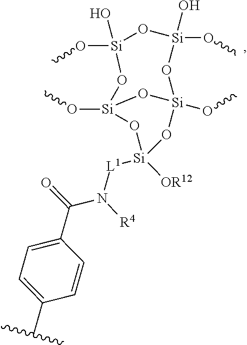

wherein R⁴, R¹², and L¹ are as defined above. In certain embodiments, R⁴ is hydrogen at each occurrence, and L¹ is C₃-alkylene at each occurrence.

In certain embodiments, the surface-modified polymer compositions comprise groups of the formula:

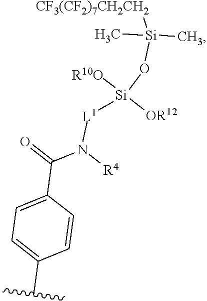

wherein R⁴, R¹⁰, R¹², and L¹ are as defined above. In certain embodiments, R⁴ is hydrogen at each occurrence, and L¹ is C₃-alkylene at each occurrence. In certain embodiments, one or both of R¹⁰ and R¹² are CF₃(CF₂)₇CH₂CH₂Si(CH₃)₂O—.

It is to be understood that linkages to the bulk polymer may be formed, for example, through reaction between amine functionalities of multifunctional linkers and ester or amide bonds of the starting polymer. The surface group may be linked to the composition through reaction with one or more functionalities of the multifunctional linkers covalently bonded to the bulk polymer.

The thickness of the surface group on the surface-modified polymer may depend on its method of deposition. In certain embodiments, the surface group on the surface-modified polymer having been deposited via spin-coating can have a thickness of about 6 nm to 200 nm, or 7 nm to 160 nm, or 8 nm to 120 nm, or 9 nm to 80 nm, or 10 nm to 40 nm. In certain embodiments, the surface group on the surface-modified polymer having been deposited via dip-coating or a sol-gel process can have a thickness of about 10 nm to 60 m, or 50 nm to 50 m, or 90 nm to 40 m, or 130 nm to 30 m, or 160 nm to 20 m. The thickness of the surface groups on the surface-modified polymer can be measured by variable angle ellipsometry or a thickness gage as determined by one of ordinary skill in the art.

### A. Polymers

A variety of polymeric materials may be used as substrate materials. Examples of suitable polymeric substrate materials include, but are not limited to, polyesters (PEs), polyamides (PAs), polycarbonates (PCs), polyurethanes (PUs), polyacetals, polysulfones, polyphenylene ethers (PPEs), polyether sulfones, polyimides, polyether imides, polyether ketones, polyether-ether ketones, polyarylether ketones, polyarylates, polyphenylene sulfides and polyalkyls.

In certain embodiments, the polymer is a polyester. Polyesters are used, for example, in the textile industry for the manufacture of polyester fibers, fabrics, disposable beverage bottles, and food packaging. The polyesters may be homo- or copolyesters. Such polyesters may, for example, comprise repeat units comprising a first residue from a monomer comprising acid or ester moieties joined by an ester linkage to a second residue from a monomer comprising alcohol moieties. The polyester may be derived from aliphatic, cycloaliphatic or aromatic dicarboxylic acids and diols or hydroxycarboxylic acids. Exemplary repeating units are, for example, ethylene terephthalate, ethylene isophthalate, ethylene naphthalate, diethylene terephthalate, diethylene isophthalate, diethylene naphthalate, cyclohexylene terephthalate, cyclohexylene isophthalate, cyclohexylene naphthalate, and the like. Such polyesters may comprise more than one type of repeating group and may sometimes be referred to as copolyesters. Exemplary polyesters are polyethylene terephthalates (PET), polyethylene naphthalates (PEN), polypropylene terephthalates (PPT), polybutylene terephthalates (PBT), and polyethylene glycol-modified polyethylene terephthalates (PETG). Suitable polyesters include, but are not limited to, EASTAR® PETG 6763 copolyester, EASTAPAK® 9921 polyester, and EASTOBOND® 19411 copolyester (EASTAR and EASTAPAK are trademarks of Eastman Chemical Company, EASTOBOND is a trademark of Eastman Kodak Company).

In certain embodiments, the polymer is a polyethylene terephthalate. PET films are among the toughest of plastic films. PET possesses excellent fatigue and tear strength, high chemical resistance, and low CO₂ permeability. PET has a high degree of clarity, it is lightweight, it is easy to manufacture, and has a relatively low cost. It can also be recycled multiple times without significant loss of its mechanical properties. In certain embodiments, the polyethylene terephthalate is EASTAPAK® 9921, 0.80 ltV (dL/g) polyethylene terephthalate copolymer. The polymers can be amorphous polyethylene terephthalate or biaxially oriented polyethylene terephthalate.

### B. Multifunctional Linkers

The multifunctional linker (also referred to herein as a “multifunctional surface-modifier”) can be used to activate the polymer so that it is susceptible to reacting with a surface group. For example, the multifunctional linker may covalently bond to the polymer on one end and to the surface group on the other end and in doing so, links the surface group to the polymer.

The multifunctional linker can be an organofunctional silane. Examples of organofunctional silanes include, but are not limited to, 3-glycidoxypropyltrimethoxysilane, 3-glycidoxypropyltriethoxysilane, 3-glycidoxypropylmethyldimethoxysilane, 3-glycidoxypropylmethyldiethoxysilane, 3-aminopropyltrimethoxysilane, 3-aminopropyltriethoxysilane, 3-aminopropylmethyldimethoxysilane, 3-aminopropylmethyldiethoxysilane, 3-(2-aminoethyl)aminopropyltrimethoxysilane, 3-mercaptopropyltrimethoxysilane, 3-mercaptopropyltriethoxysilane, 3-mercaptopropylmethyldimethoxysilane, 3-mercaptopropylmethyldiethoxysilane, N-[2(vinylbenzylamino)ethyl]3-aminopropyltrimethoxysilane, 4-aminobutyltriethoxysilane, (aminoethylaminomethyl)phenethyltrimethoxysilane, N-(2-aminoethyl)-3-aminopropylmethyldimethoxysilane, N-2-aminoethyl-3-aminopropyltris(2-ethylhexoxy)silane, 6-(aminohexylaminopropyl)trimethoxysilane, p-aminophenyltrimethoxysilane, 3-(1-aminopropoxy)-3,3-dimethyl-1-propenyltrimethoxysilane, 3-aminopropyltris(methoxyethoxyethoxy)silane, 3-aminopropylmethyldiethoxysilane, and w-aminoundecyltrimethoxysilane, and partial hydrolyzates of any thereof. In certain embodiments, organofunctional alkoxysilanes are used as multifunctional linkers, such as aminofunctional alkoxysilanes. In certain embodiments, the multifunctional linker is 3-aminopropyltriethyoxysilane (APTES), 3-aminopropyltrimethoxysilane (ATMS), 3-aminopropyltriisopropoxyoxysilane, or 3-aminopropyltributoxysilane.

In certain embodiments, the multifunctional linker has the formula:

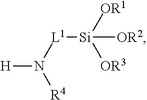

wherein R¹, R², and R³ are each independently selected from the group consisting of hydrogen, optionally substituted C₁-C₆-alkyl, and optionally substituted aryl; R⁴ is hydrogen or C₁-C₆-alkyl; and L¹ is C₁-C₁₀-alkylene. In certain embodiments, R¹, R², and R³ are each methyl. In certain embodiments, R¹, R², and R³ are each ethyl. In certain embodiments, R⁴ is hydrogen. In certain embodiments, L¹ is C₃-alkylene. In certain embodiments, R¹, R², and R³ are each ethyl; R⁴ is hydrogen; and L¹ is C₃-alkylene.

### C. Surface Groups

The surface group can be used to functionalize the polymer activated with a multifunctional linker, and in doing so, impart selected properties to the composition surface. In certain embodiments, the surface group is a tetramethyl orthosilicate, a tetraethyl orthosilicate, a tetraisopropyl orthosilicate, a tetrabutyl orthosilicate, a tetrapropoxysilane, or a sodium silicate. In certain embodiments, the surface group has formula Si(OR)₄ wherein R, at each occurrence, is independently selected from the group consisting of optionally substituted alkyl and optionally substituted aryl. In certain embodiments, the surface group is fluorodecyltrichlorosilane, undecenyltrichlorosilane, vinyl-trichlorosilane, decyltrichlorosilane, octadecyltrichlorosilane, dimethyldichlorosilane, decenyltrichlorosilane, fluoro-tetrahydrooctyl trimethylchlorosilane, perfluorooctyldimethylchlorosilane, fluoropropylmethyldichlorosilane, perfluorodecyldimethylchlorosilane, or 1H,1H,2H,2H-perfluorodecyldimethylchlorosilane. In certain embodiments, the surface group may be a biological material. Exemplary biological materials include, but are not limited to, oligonucleotides (e.g., DNA, RNA), proteins, peptides, and antibodies.

### 3. Synthetic Methods

In another aspect, disclosed are methods of preparing surface-modified polymer compositions. The disclosed methods may provide several advantages over non-aqueous-based processes. For example, the reaction conversion may be greater in comparison to a non-aqueous-based process. The reaction rate may be faster in comparison to a non-aqueous-based process. As another advantage, it was unexpectedly found that dilution of APTES in water to a concentration of 1% v/v or less, results in a stable compound. According to the Safety Data Sheet for APTES, APTES is moisture sensitive and is expected to polymerize upon water exposure. This finding allows for modification of polymers (e.g., polyethylene terephthalate) with APTES in water.

In certain embodiments, a method of preparing a surface-modified polymer composition includes the step of reacting a polymer with a multifunctional surface-modifier in aqueous solution.

The concentration of the multifunctional surface-modifier in the aqueous solution may be between 0.2% v/v to 5% v/v, or 0.3% viv to 4% v/v, or 0.4% v/v to 3% v/v, or 0.5% viv to 2% v/v. The concentration of the multifunctional surface-modifier in the aqueous solution may be, for example, 0.5-2% v/v, or 1% v/v or less. The reaction between the polymer and the multifunctional surface-modifier in aqueous solution may be complete in 5 hours or less, 4 hours or less, 3 hours or less, 2 hours or less, or 1 hour or less, as measured by one or more of XPS, TOF-SIMS, and FT-IR. The reaction may be complete, for example, within 3 hours or less, or L hour or less. The reaction may be conducted at ambient temperature or greater. In certain embodiments, the reaction rate may be increased by conducting the reaction at higher temperatures.

In certain embodiments, a method of modilfing the surface of a polyester includes preparing an aqueous solution of a multifunctional amine compound at a concentration of 0.5-2% viv; mixing the aqueous solution; adding a polyester to the aqueous solution and mixing the aqueous solution comprising the polyester and multifunctnctional amine to provide a surface-modified poly ester. The surface-modified polyester can be isolated from the aqueous solution and thereafter rinsed and dried.

In certain embodiments, the method may further include rinsing the reaction product. The reaction product may be rinsed with aqueous acid having a pH of about 3, a pH of about 4, or a pH of about 5. The reaction product may be rinsed with a mineral acid or carboxylic acid. This rinsing step may inhibit the formation of islands/multilayers on the surface-modified polymer.

The resulting surface-modified polymer composition may include a uniform topography, as measured by atomic force microscopy imaging. The surface-modified polymer composition may include a surface uniformly covered with the multifunctional surface-modifier, as measured by time of flight secondary ion mass spectrometr. This surface-modified polymer composition may include a modified surface having a thickness of about 0.7 nanometers, as measured by variable angle spectroscopic ellipsometry

In certain embodiments, a method of modifying the surface of a polyester includes the steps of (a) preparing an aqueous solution of a multifunctional amine compound; (b) mixing the aqueous solution; (c) adding a polyester to the aqueous solution; and (d) mixing the aqueous solution comprising the polyester and multifunctional amine to provide a surface-modified polyester. The resulting surface-modified polyester can be isolated from the aqueous solution and rinsed.

In certain embodiments, a method of modifying the surface of a polymer can include reacting a polymer with a multifunctional linker in aqueous solution to provide a first surface-modified polymer. One or more functional groups of the first surface-modified polymer can be hydrolyzed to provide a second surface-modified polymer. The second surface-modified polymer can be reacted with a surface group (also referred to as a “surface modifier”) to provide a third surface-modified polymer. The surface group can be applied to the second surface-modified polymer by, for example, spin-casting, dip-coating, or a sol-gel process. If spin-coating is used to apply the surface group on the second surface-modified polymer, the thickness of the surface group on the third surface-modified polymer may be about 10-200 nm. If dip-coating is used to apply the surface group on the second surface-modified polymer, the thickness of the surface group on the third surface-modified polymer may be 0.1-10 itm. One or more steps in the methods can optionally be conducted in situ or without isolation of a selected product.

In certain embodiments, a method of preparing a surface-modified polymer includes the steps of (a) preparing a solution by mixing a water-soluble, multifunctional molecule containing at least one primary amine solution with water; (b) combining the solution with a polyester to form a covalent bond between the primary amine and the polyester; (c) isolating and rinsing the reacted polyester; (d) preparing a mixture of surface group reactant (e.g., a silicate solution); and (e) depositing the mixture (e.g., a silicate solution) onto the reacted polyester so as to form a surface-modified polymer.

The present disclosure also involves a method for the modification of the surface of various polymers with APTES in aqueous solution followed by coating with partially hydrolyzed tetraethyl orthosilicate (TEOS). APTES can act as an adhesion promoter between the polyester and the silicate layer. The silicate layer can significantly improve the solvent resistance of the polymer. The composition can include a partially hydrolyzed tetraethyl orthosilicate layer. The silicate layer on the polymer may include a uniform topography as confirmed by atomic force microscopy imaging. It may also be a wettable surface, as shown by water contact angle measurements.

The compositions, compounds and intermediates used in the methods may be isolated and purified by techniques well-known to those skilled in the art of organic synthesis. Examples of conventional methods for isolating and purifying compounds can include, but are not limited to, chromatography on solid supports such as silica gel, alumina, or silica derivatized with alkylsilane groups, by recrystallization at high or low temperature with an optional pretreatment with activated carbon, thin-layer chromatography, distillation at various pressures, sublimation under vacuum, and trituration, as described for instance in “Vogel's Textbook of Practical Organic Chemistry”, 5th edition (1989), by Fumrniss, Hannaford, Smith, and Tatchell, pub. Longman Scientific & Technical, Essex CM20 2JE, England.

Reaction conditions and reaction times for each individual step can vary depending on the particular reactants employed and substituents present in the reactants used. Specific procedures are provided in the Examples section. Reactions can be worked up in the conventional manner, e.g., by eliminating the solvent from the residue and further purified according to methodologies generally known in the art such as, but not limited to, crystallization, distillation, extraction, trituration and chromatography. Unless otherwise described, the starting materials and reagents are either commercially available or can be prepared by one skilled in the art from commercially available materials using methods described in the chemical literature. Starting materials, if not commercially available, can be prepared by procedures selected from standard organic chemical techniques, techniques that are analogous to the synthesis of known, structurally similar compounds, or techniques that are analogous to the above described schemes or the procedures described in the synthetic examples section.

Routine experimentations, including appropriate manipulation of the reaction conditions, reagents and sequence of the synthetic route, protection of any chemical functionality that cannot be compatible with the reaction conditions, and deprotection at a suitable point in the reaction sequence of the method are included in the scope of the invention. Suitable protecting groups and the methods for protecting and deprotecting different substituents using such suitable protecting groups are well known to those skilled in the art; examples of which can be found in PGM Wuts and TW Greene, in Greene's book titled Protective Groups in Organic Synthesis (4^{th} ed.), John Wiley & Sons, NY (2006), which is incorporated herein by reference in its entirety. Synthesis of the compounds of the invention can be accomplished by methods analogous to those described in the synthetic schemes described hereinabove and in specific examples.

When an optically active form of a disclosed compound is required, it can be obtained by carrying out one of the procedures described herein using an optically active starting material (prepared, for example, by asymmetric induction of a suitable reaction step), or by resolution of a mixture of the stereoisomers of the compound or intermediates using a standard procedure (such as chromatographic separation, recrystallization or enzymatic resolution).

Similarly, when a pure geometric isomer of a compound is required, it can be obtained by carrying out one of the above procedures using a pure geometric isomer as a starting material, or by resolution of a mixture of the geometric isomers of the compound or intermediates using a standard procedure such as chromatographic separation.

### 4. Method of Use

The surface-modification of polymers as disclosed herein serves as a platform to endow the surface with various functionalities. These surface functionalities include, but are not limited to, biocidal, antifouling, hydrophilic coatings for biomedical applications; biocidal and anti-fouling finishes for filtering applications; and hydrophobic surfaces for self-cleaning applications.

In certain embodiments, the surface-modification of polymers can be directed to biomedical applications, such as implants, tissue scaffolds, and medical sutures. In such applications, a hydrophilic surface may be desired to encourage cell adhesion. In certain embodiments, the surface-modification of polymers can be directed to anti-fouling to minimize protein adhesion, and anti-bacterial to minimize infections. In certain embodiments, the surface-modification of polymers can be directed to water filtration, anti-fouling and biocidal character to increase lifetime of filters and eliminate pathogens in drinking water. In certain embodiments, the surface-modification of polymers can be directed to self-cleaning surfaces by endowing the surface with hydrophobicity. In certain embodiments, the surface-modification of polymers can be directed to scratch resistance properties, which may be of use in display applications, such as touch-screens and flexible displays.

Articles that can include the compositions of the surface-modified polymers include, but are not limited to, a microchannel, a microfilter, a microinjector, a display device, a touch-screen, a flexible display, a packaging, a gas-impenetrable packaging, a biomedical device, an implant, a tissue scaffold, a medical suture, an anti-fouling device or coating, a filter, a biocidal device or coating, a hydrophobic coating, a hydrophilic coating, an anti-bacterial device or coating, a self-cleaning surface, an electronic device, a medical device, an article of clothing, a household product, a consumer product, a building material, a sewer device or coating, a food processing device, a ship or boat, a vessel hull, a paper manufacturing device, a cooling water system, a marine engineering system, an adhesive, insulation, and a computer.

### 5. Examples

The present disclosure has multiple aspects, illustrated by the following non-limiting examples. In the various examples, the below materials and characterization techniques have been used.

Materials:

PET (Eastapak™ 9921) pellets and film were provided by Eastman Chemical Company. 2-chlorophenol, perfluoro(methyldecalin), 40 w/w % aqueous methylamine, and APTES were purchased from Sigma-Aldrich. 4-Methylbenzoic acid was purchased from Acros Organics. Sulfuric acid was purchased from Fisher. Methanol was purchased from Macron Fine Chemicals. Chromatography solvents and n-propylamine were purchased from Alfa Aesar. Column chromatography was performed on silica gel cartridges purchased from Biotage. 1H,1H,2H,2H-perfluorodecyldimethylchlorosilane was purchased from Gelest. All chemical were used as received. Silicon wafers (p-type, boron-doped, orientation <100>) were purchased from Silicon Valley Microelectronics.

Characterization:

1) AFM Measurements

Surface topography was imaged using an Asylum Research MFP-3D Origin AFM in non-contact (tapping) mode. Silicon tips, model AC160TS, with a radius of 9±2 nm, a frequency of 300 (200-400) kHz, and a spring constant of 42 (12-103) N/m were used. All AFM images have a 512×512 pixel resolution at a scan rate of 0.5 Hz. The root-mean-square (RMS) surface roughness was calculated using a 5×5 μm² scan area. All images were processed and analyzed using IgorPro software.

2) Ellipsometry

Film thickness was measured using variable angle spectroscopic ellipsometry (J. A. Woollam) at a 700 angle of incidence (relative to the sample normal). Each layer was modeled as a Cauchy layer. Film thickness was measured before and after each modification step.

3) FTIR

Infrared spectra were taken using a Bruker ALPHA Platinum single reflection diamond ATR-FTIR spectrometer scanning between 400 and 4000 cm⁻¹ with a resolution of 4 cm⁻¹. Small molecules were introduced by placing several mg of material into the sample well, and pressed between the well and the diamond reflectometer. Spectra of thin films were taken by placing glass slides sample side down before scanning using the gold on glass backing as a reflective layer.

4) Mass Spectrometry

Mass spectra of surfaces were collected using a TOF-SIMS 5 from ION-TOF GmbH, using a bismuth ion source and an ION-TOF reflectron energy compensating TOF mass analyzer with ˜2 meter path length. Mass Spectrometry analysis of small molecules was carried out on a high resolution mass spectrometer—the Thermo Fisher Scientific Exactive Plus MS, a benchtop full-scan Orbitrap™ mass spectrometer—using Heated Electrospray Ionization (HESI). Samples were dissolved in methylene chloride and acetonitrile and analyzed via syringe injection into the mass spectrometer at a flow rate of 20 μL/min. The mass spectrometer was operated in positive ion mode.

5) NMR

Nuclear Magnetic resonance experiments were performed on a 300 MHz ¹H, 75 MHz ¹³C Varian spectrometer. Spectra were Fourier-transformed and analyzed using the ACD software.

6) XPS

Surface chemical analysis was performed using a Kratos Analytical Axis Ultra spectrometer at a take-off angle of 90 and 15° (i.e., angle between the plane of the film and the entrance lens of the detector optics). The XPS used an Al monochromated x-ray source. The pass energies used were 160 and 20 eV for survey and high resolution respectively. The resolutions used were 1 and 0.1 eV for survey and high resolution respectively. All spectra were calibrated to the carbon aliphatic peak and were analyzing using the CasaXPS software. All synthetic components were modeled using Gaussian-Lorentzian peaks. The full-width-at-half-maximum (FWHM) was constrained such that all peaks' FWHM were within +0.2 eV of each other.

7) Water Contact Angle

Water contact angles were measured using the sessile drop technique on a Ramé-Hart Model 100-00 goniometer. Deionized (DI) water was used to measure the water contact angle of all substrates before and after each modification step. The droplet volume was 6 μL. The reported contact angle is the average of the left and right contact angle of the droplet on the surface. Three measurements were taken on every sample.

### Example 1. Preparation of Thin, PET Films

Procedure:

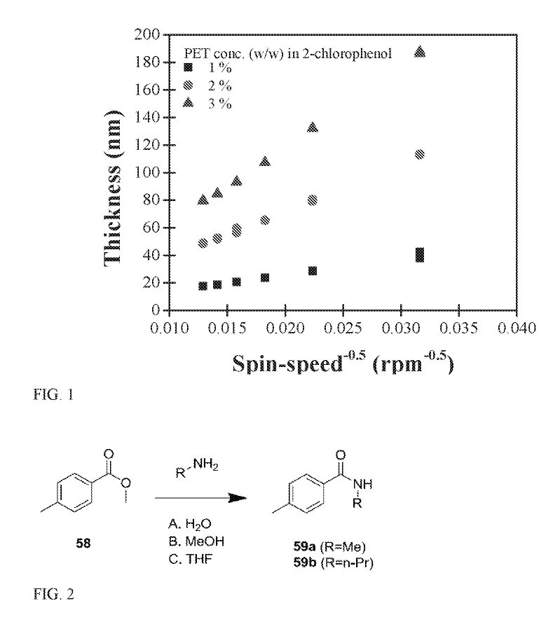

PET pellets were dissolved by heating them in 2-chlorophenol at concentrations between 0.5 and 3.0% (w/w). Once dissolved, each polymer solution was filtered using a 0.2 gm PTFE filter to remove any particulates and undissolved polymer. Silicon wafers were rinsed with methanol followed by UVO treatment for 5 minutes to remove any organic contaminants on the surface. Thin PET films having thicknesses between 10 and 200 nm were spin-coated onto the silicon wafer segments measuring 1 cm×1 cm by varying the polymer concentration and spin-speed as shown in FIG. 1. Thin films were dried in air for at least one hour followed by drying under vacuum at room temperature for at least 24 hours. Spin-coated PET films were uniform and smooth as assessed via optical microscopy and atomic force microscopy (AFM). The root-mean-square (RMS) surface roughness obtained from a 5×5 μm² AFM scan for a spin-coated PET film was =0.2 nm.

Spin-cast PET films using this procedure are highly amorphous.

### Example 2. Rapid Aminolysis of Esters Under Aqueous Conditions

### A. Synthesis of Methyl-4-Methylbenzoate—Small Molecule Analogue of PET

To identify the appropriate conditions for aminolysis of polyesters with primary amines, reactions were first studied using a small molecule analogue of PET. The products of the reaction between the small molecule analogue and a primary amine can be isolated and characterized using traditional analytical methods (NMR, IR, MS). Methyl-4-methylbenzoate was chosen as a suitable analogue for PET due to its similarity in structure to the ester in the PET repeat unit. Methyl-4-methylbenzoate was synthesized using Fischer-Speier esterification in methanol with catalytic sulfuric acid.

Procedure:

In a 20 mL round bottomed flask, 4-methylbenzoic acid (1.36 g, 0.01 mol), methanol (10 mL), and a catalytic amount of concentrated H₂SO₄ (˜1 drop) were combined and stirred at reflux for 12 hours. Methanol was then removed under reduced pressure. The crude material was taken up in ethyl acetate and washed three times with deionized water. The organic layer was dried over sodium sulfate, the solvent was removed under reduced pressure, and the resulting crude material was purified via silica column chromatography eluting with a gradient from 0 to 10% ethyl acetate/hexanes solution. The product was the first compound to come off of the column. Removal of the solvent afforded a thin clear residue. Yield: 1.10 g (73%). ¹H-NMR (300 MHz, CDCl₃) δ ppm 7.87 (d, 2H), 7.17 (d, 2H), 3.83 (s, 3H), 2.34 (s, 3H).

### B. Study of Rate of Amidation of Methyl-4-Methylbenzoate

There are a number of studies in the literature on the rates of amidation of small molecule esters, particularly acetate and phenyl esters. One of the notable differences in the systems previously studied is the use of aqueous conditions, as opposed to anhydrous conditions in organic solvents. In fact, several early studies noted that the reaction of benzoic acid esters with ammonia was too slow to be measured in methanol. However, no reports were found on the rates of amidation of aromatic esters analogous to that in the repeat unit of the PET under aqueous conditions to date. To study this, the PET analogue was reacted with two different primary amines, methylamine, and propylamine, under various conditions as shown in FIG. 2. FIG. 2 shows the reaction of methyl-4-methylbenzoate, the small molecule PET analogue, with a small chain primary amine to generate the amide under various solvent conditions.

### 1. Synthesis of N,4-dimethylbenzamide

Procedure:

In a 5 mL scintillation vial, methyl-4-methylbenzoate (0.116 g, 0.776 mmol) and 2 mL of 20% w/w aqueous methyl amine were combined and stirred at room temperature (approximately 25° C.) for 12 hours. The crude reaction was extracted three times with dichloromethane. The organic layer was dried over sodium sulfate and the solvent was removed under reduced pressure. The resulting crude material was purified via silica column chromatography eluting with 4% methanol/dichloromethane solution. The product was the second compound to come off of the column. Removal of the solvent afforded a fluffy white solid. Yield: 0.0914 g (79%). ¹H-NMR (300 MHz, CDCl₃) δ ppm 7.70 (d, 2H), 7.24 (d, 2H), 6.63 (s, 1H), 3.02 (d, 3H), 2.42 (s, 3H). ¹³C-NMR (75 MHz, CDCl₃) δ 21.3, 26.6, 126.8, 128.9, 131.6, 141.5, 168.3. MS (ESI) m/z 150.0912 [M+H]⁺.

### 2. Synthesis of 4-methyl-N-propylbenzamide

Procedure:

In a 5 mL scintillation vial, methyl-4-methylbenzoate (0.119 g, 0.715 mmol) and 2 mL of 20% w/w aqueous propyl amine were combined and stirred at room temperature for 12 hours. The crude reaction was extracted three times with dichloromethane. The organic layer was dried over sodium sulfate and the solvent was removed under reduced pressure. The resulting crude material was purified via silica column chromatography eluting with 4% methanol/dichloromethane solution. The product was the second compound to come off of the column. Removal of the solvent afforded a fluffy white solid. Yield: 0.0446 g (35%). ¹H-NMR (300 MHz, CDCl₃) δ ppm 7.71 (d, 2H), 7.25 (d, 2H), 6.33 (s, 1H), 3.44 (q, 2H), 2.42 (s, 3H), 1.66 (m, 2H), 1.01 (t, 3H). ¹³C-NMR (75 MHz, CDCl3) δ 11.3, 21.2, 22.8, 41.6, 126.8, 128.9, 131.9, 141.4, 167.5. MS (ESI) m/z 178.1229 [M+H]⁺.

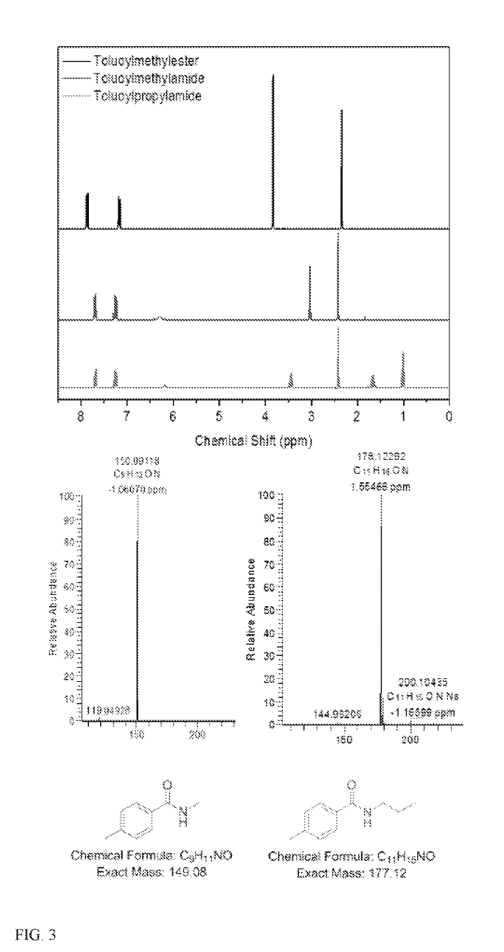

When conducted in water, methylamide and propylamide were obtained in 79%, and 35% yields, respectively as evidenced by NMR and mass spectrometry characterization in FIG. 3. FIG. 3 shows the ¹H-NMR and mass spectra of toluoylmethylester, toluoymethylamide, and toluoylpropylamide. These reactions were also conducted in methanol and tetrahydrofuran. Even with longer reaction times (120 h) and higher reaction temperatures (60° C.), no amide product was detected by thin layer chromatography or after workup of the reactions, with the exception of methanolic methylamine, which afforded a 9% yield after chromatography, as shown below in Table 1.

TABLE 1

| Amine | H2O | Methanol | THF |
|---|---|---|---|
| Methylamine | 78% | 9% | 0% |
| n-proplylamine | 35% | 0% | 0% |

### C. Aminolysis of Shredded PET

The aqueous aminolysis conditions found using the small molecule analogue were applied to the aminolysis of PET.

Procedure:

A 3 g portion of 250 μm thick, amorphous, free-standing PET film (Eastapak™ 9921 copolyester) was shredded using scissors and placed in a 25 mL scintillation vial. A 20% w/w aqueous amine solution (methylamine or n-propylamine) was used to fill the vial, and the vial was then tightly capped. The vials were placed on a shaker table at 250 rpm at room temperature for 12 hours. The resulting solution was filtered from the remaining shredded PET and the filtrate was concentrated in-vacuo, yielding an off-white residue, which was analyzed by infrared spectroscopy (ATR-FTIR).

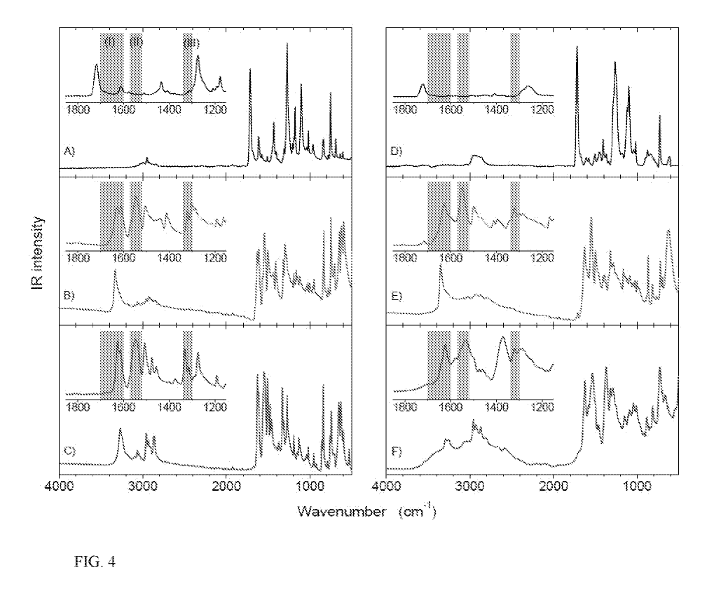

Aminolysis of PET fibers with aqueous methylamine has been reported in Farrow G., et al., Polymer, 3:17-25 (1962). The glycol soluble portion of the reaction showed IR bands at 1630 and 1543 cm⁻¹ as evidence of aminolysis. In the present disclosure, free-standing PET films (250 μm thick) were shredded and treated with aqueous methylamine and aqueous propylamine. The solution from these reactions was concentrated and showed IR bands that are concurrent with the IR bands of both the methyl and propylamide small molecule analogues (3300, 1650 (I), 1550 (II), and 1330 (III) cm⁻¹, FIG. 4). Similar experiments carried out in ethanol produced no such amide bands from aminolysis, leading to the conclusion that aminolysis of polyesters by primary amines occurred readily only under aqueous conditions.

### D. Aminolysis of Shredded PET

Additional direct evidence of the amidation of PET under aqueous conditions was sought by using spin-coated PET on gold-backed glass slides.

Procedure:

Aqueous solutions of 1% v/v APTES were prepared in deionized (DI) water. APTES was added slowly to DI water with stirring. The solution was stirred for at least one hour prior to any reaction. Spin-coated PET thin films were placed in the reaction solution for one hour at room temperature. The samples were then removed and rinsed with copious amounts of DI water followed by aqueous acetic acid (pH 4). Samples were then dried with nitrogen gas.

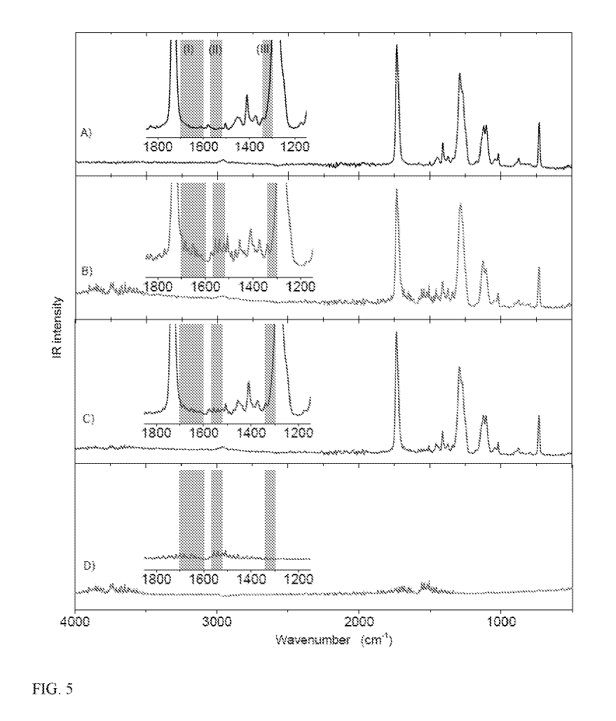

Previous attempts to identify amide bands in the infrared spectrum of PET treated with amines, suffered from poor signal-to-noise ratio. Using thin films of PET on reflective gold-backed slides allowed for the use of ATR-FTIR spectroscopy with repeated scanning to improve the signal to noise ratio. FIG. 5 shows IR spectra of the PET films treated with 1% (w/w) aqueous methylamine, 1% (v/v) aqueous APTES, and 20% (w/w) methylamine. The low amine loading reactions produced amide bands in the amide regions. The amide III band was largely obscured, but bands in the amide I and amide II region were observed. These bands were more numerous and thus more complex than those obtained from the solution residue (FIG. 4), consistent with functionalization of a chemically heterogeneous surface. Use of 20% methylamine completely destroyed the film as evidenced by the lack of corresponding ester peak from the PET. These results suggest that both aqueous methylamine and aqueous APTES produce covalently bound alkyl amines and APTES on the surface of PET films and indicate the relative concentration of amine that is ideal for this surface functionalization.

### Example 3. Measuring the Thickness and Evaluating the Surface Topography of the APTES Layer on the Treated PET Thin Films

Amidation of PET surface was further characterized by spin-coating thin PET films onto silicon wafers.

Procedure:

Spin-coated PET films were placed in an aq. 1% (v/v) APTES solution for one hour at room temperature. Thickness of each sample was measured before and after the aminolysis reaction via ellipsometry. A thickness increase after the aminolysis reaction corresponds to deposition of APTES molecules onto the surface. AFM imaging was also performed before and after aminolysis reaction to see if there were any changes in the surface topography of PET thin films. XPS measurements at two different take-off angles were utilized to analyze chemical changes on the surface of the PET specimens before and after aminolysis. ToF-SIMS was employed to obtain information about the lateral (e.g., in-plane) chemical uniformity of amidated PET surfaces. The sampling depth of ToF-SIMS is ≈1 nm when using a low primary ion beam-current density and low voltage as in this study. Bismuth ions are used to bombard the PET surface, which results in the emission of charged and neutral fragments from the top ˜1 nm of surface. These fragments (both positive and negative) are passed through a mass spectrometer to obtain a mass spectrum. In this study, only the negative ions were analyzed.

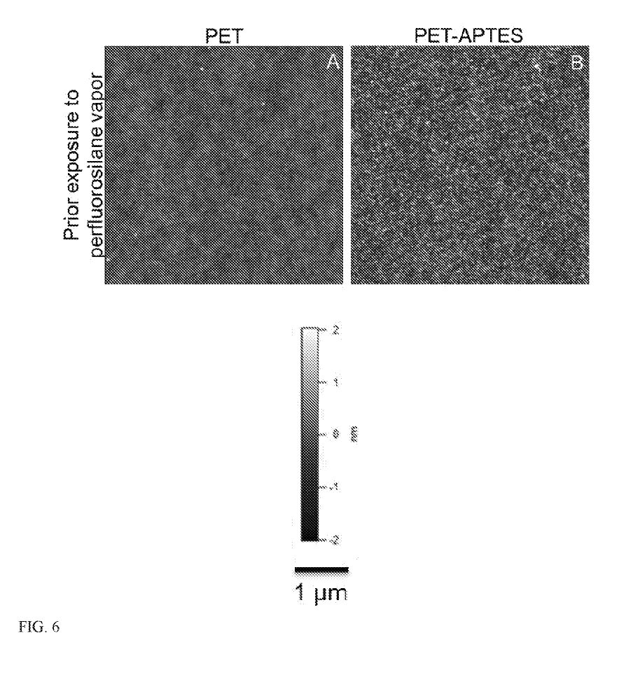

Spin-coated PET on silicon wafer was used to monitor the change in thickness in PET films amidated using aq. 1% (v/v) APTES for one hour. As shown in Table 2, the average thickness of the APTES layer was ˜0.7 nanometers. This thickness value is within the range of the theoretical length for an APTES molecule. The root mean square (RMS) surface roughness (Table 2) of APTES-treated PET increased from 0.2 nm to 0.5 nm, which is reasonable for a process that cleaved chains in the polymer. There was no significant change in the surface topography as shown by comparison of FIGS. 6A and 6B. The uniform topography in the AFM image suggests a uniform coating and a surface functionalization process that does not affect the surface morphology of the PET film.

TABLE 2

| Sample | Thickness (nm) | RMS (nm) |
|---|---|---|
| Virgin PET | 21 ± 0.2 | 0.2 |
| PET-1 hr. | 0.7 ± 0.1 | 0.5 |
| reaction with APTES | (top layer only) | |

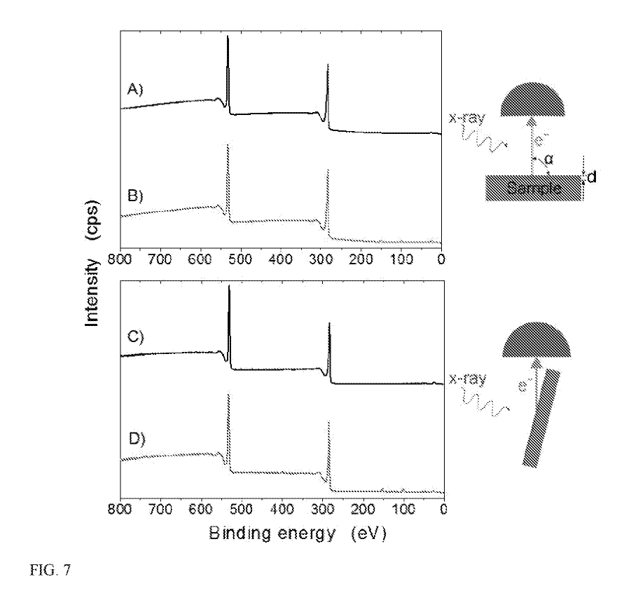

When taking XPS measurements, varying the take-off angle (α) facilitates adjusting the probing depth (d) of XPS. This is depicted in FIG. 7. d=3λ·sin(α), where λ is the electron mean free path. Using a mean free path of 2.78 nm for C 1s electrons, 95% of the electrons detected originate from the top 8-9 nm at α=90°. At α=15°, 95% of the electrons originate from the top 2-3 nm of the film. The measured APTES layer thickness is only ˜0.7 nm. XPS spectra of virgin PET (FIG. 8) shows peaks at ˜284.5, ˜286, ˜289 eV for C is region corresponding to sp2 hybridized carbon in the aromatic rings, and carbon bonded as to C—O, and O═C—O, respectively. The peaks at ˜531.8 and ˜533.4 eV correspond to oxygen bonded as O═C—O and C—O, respectively. As shown in FIG. 8, at c=90° a broad nitrogen peak appears at around 399 eV after exposing PET to 1% APTES for one hour. The appearance of silicon is also evident at binding energy of ˜102 eV. The high resolution XPS spectra at C is and O is edges collected at c=90° show no difference between virgin PET and APTES treated PET since a large portion of electrons come from the bulk PET. The C is high resolution spectrum at α=15° shows the appearance of a series of new peaks, located at ˜283.5, 285, ˜286, and ˜288 eV, which correspond to carbon bound to silicon, sp³ hybridized carbon, and carbon bonded as C—N, and amide O═C—N, respectively. The first three aforementioned peaks correspond to APTES. The peak at ˜288 eV corresponds to the amide bond. This peak also correlates with the O is high resolution peak at α=15°, which shows the appearance of two new peaks at ˜531.2 and ˜532.7 eV, corresponding to Si—O and O═C—N, respectively. The change in intensity of the nitrogen and silicon peaks between c=15° and c=90° along with the disappearance of amide and APTES peaks in the O is and C is demonstrates that the ATPES molecules do not penetrate into the bulk of PET; instead, APTES is attached on the surface via covalent binding and not surface physisorption.

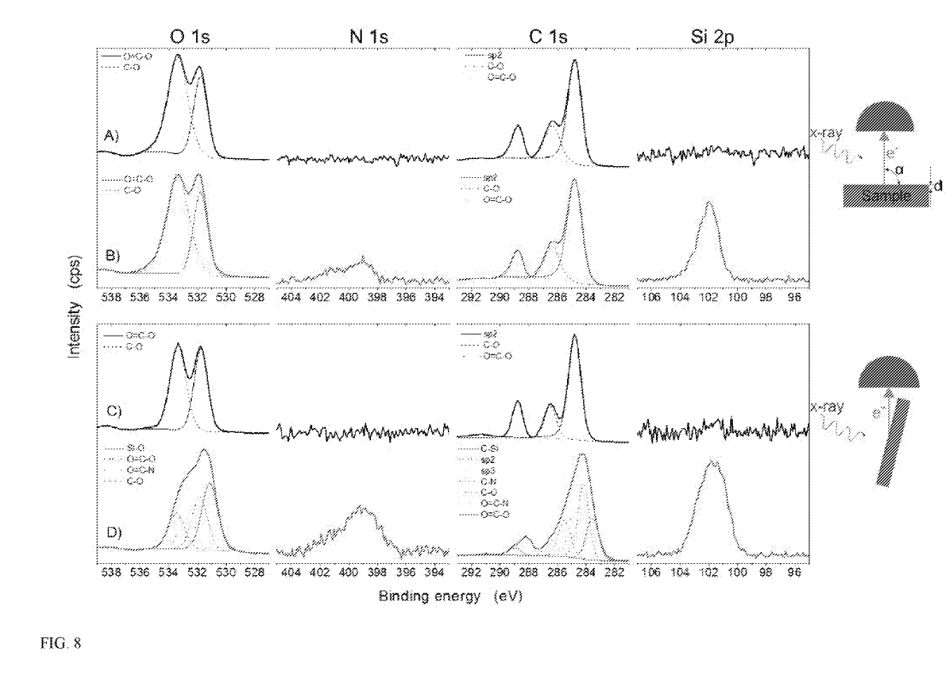

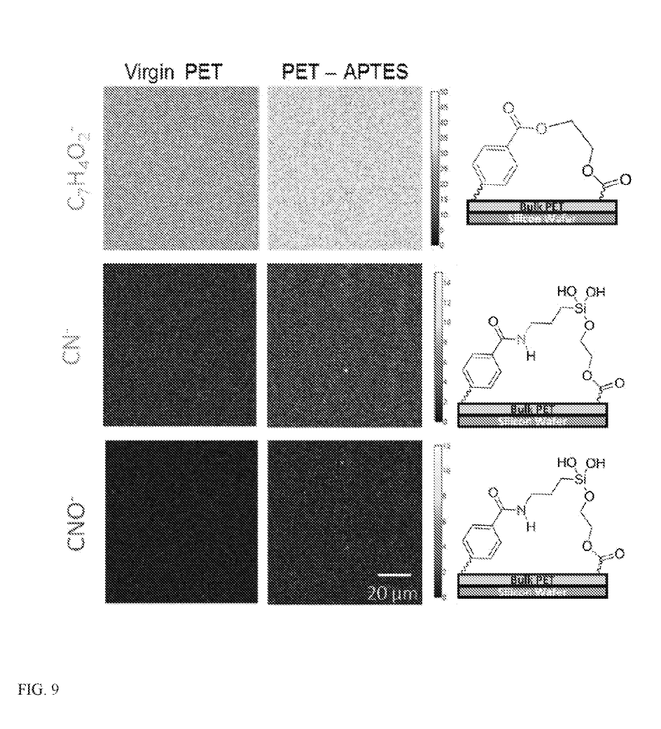

Organic molecules have a characteristic fragmentation pattern, which can be used to differentiate among chemical species present on any given surface of interest. For example, PET fragments observed in the negative ToF-SIMS spectrum include the following: C₇H₅O₂⁻ (m/z=121), C₇H₄O₂⁻ (120.02), C₆H₄⁻ (76), C₅H₅⁻ (65). For simplicity, only the C₇H₄O₂⁻ fragment will be used in the discussion below. If amide bonds are also present on the surface, the following fragments will appear on the mass spectrum: CN⁻ (m/z=26.00) and CNO⁻ (42.00). FIG. 9 shows the C₇H₄O₂⁻ fragment (m/z: 120.02), which corresponds to PET, CN⁻ (m/z: 26.02), which corresponds to APTES, and CNO⁻ (m/z: 42.03), which corresponds to APTES amidated to PET substrate. FIG. 9 depicts 100×100 m² images of virgin PET (left column) and PET after aminolysis reaction with APTES (right column). The relative intensity of the C₇H₅O₂— PET fragment (top row) decreases slightly after amidation reaction, which is indicative of surface coverage by APTES molecules. Furthermore, the relative intensity of both the CN⁻ and CNO⁻ fragments (middle and bottom row) increased upon aminolysis reaction with APTES. Based on the 100×100 μm² ToF-SIMS chemical image, one can discern that APTES is uniformly present throughout the surface as there are no islands or spots observed on the chemical images of either the PET fragment (C₇H₅O₂⁻) or the amide fragments (CN⁻ and CNO⁻). These results reveal that aminolysis reaction at a 1% v/v APTES concentration conducted for 1 hr is sufficient to uniformly amidate PET surfaces. Increasing the reaction temperature may reduce the reaction time to achieve uniform surface amidation of PET.

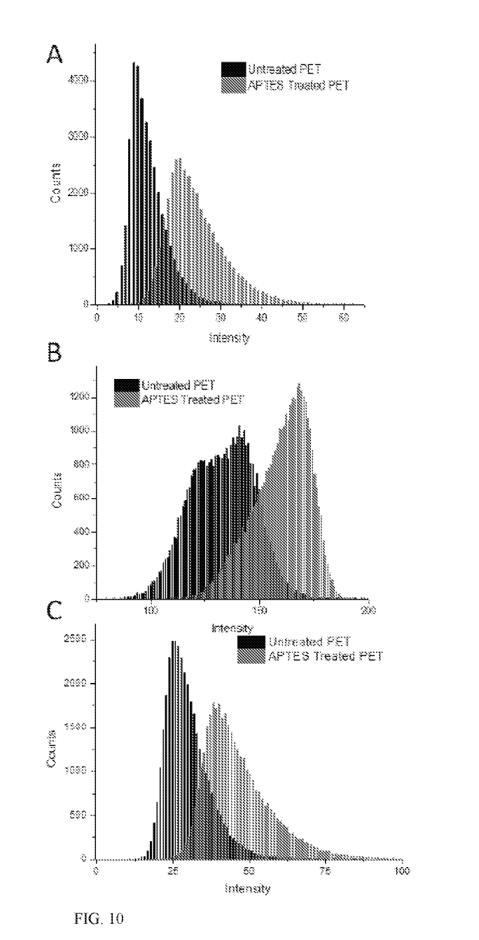

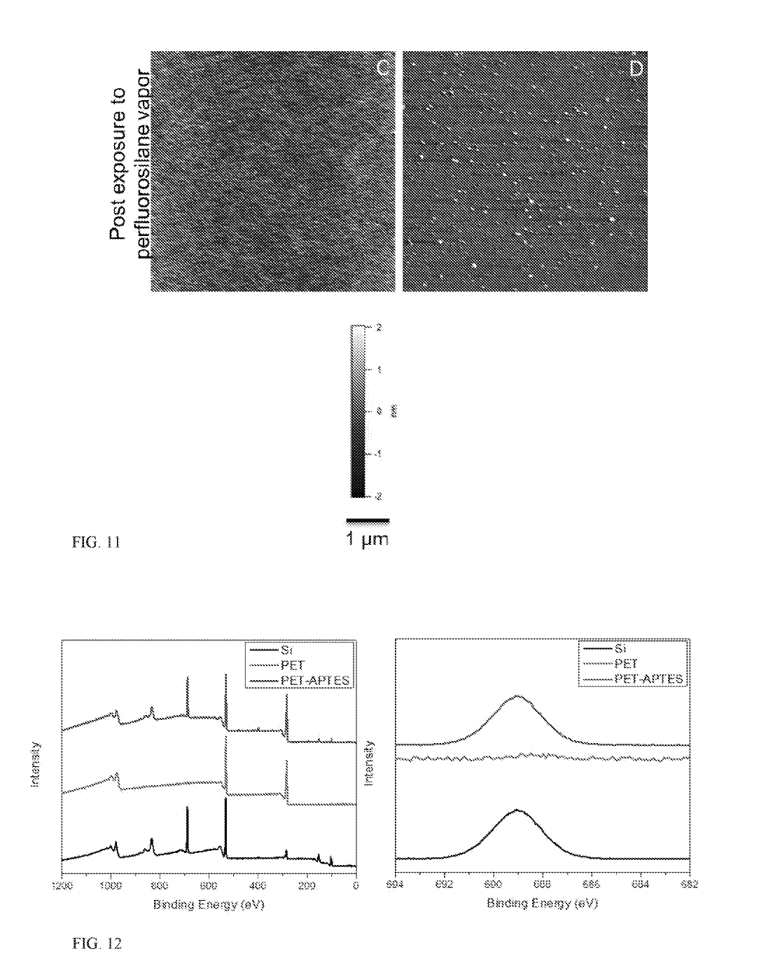

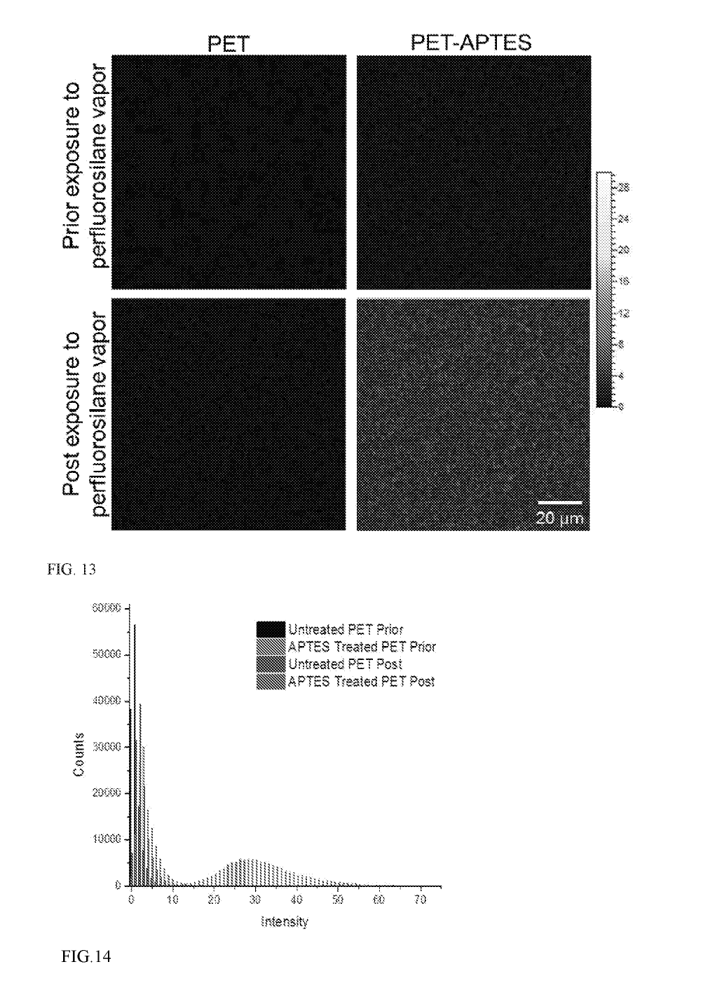

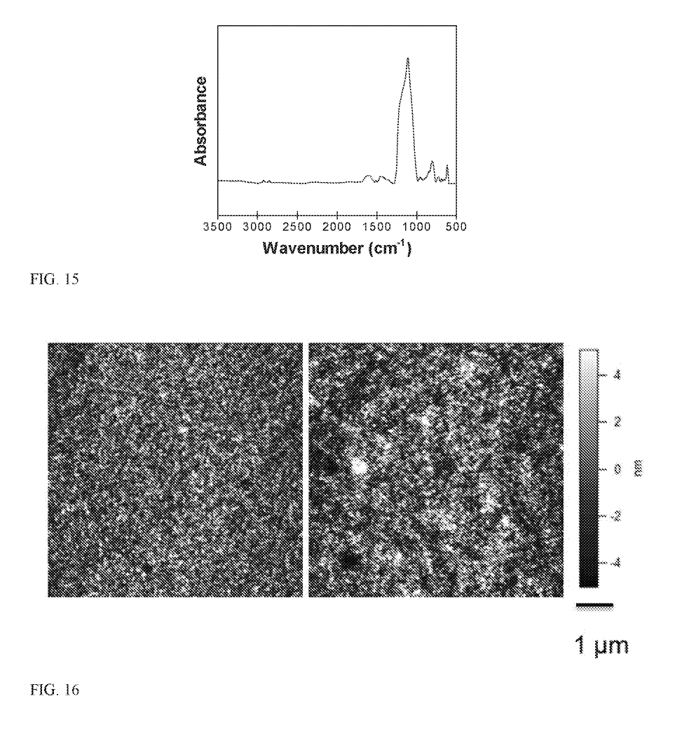

FIG. 10 shows a histogram of the pixel intensities from FIG. 9, to illustrate the increase in signal intensity from Tof-SIMS measurements. These results complement the XPS results discussed earlier. Based on the 100×100 μm² ToF-SIMS chemical image, one can discern that APTES is uniformly present throughout the surface.

### Example 4. Utility of APTES Activated PET with Respect to Further Surface Functionalization

To illustrate the utility of APTES activated PET with respect to further surface functionalization, the substrates were further reacted with 1H,1H,2H,2H-perfluorodecyldimethylchlorosilane (mF8H2) via vapor deposition. A monofunctional silane (mF8H2) was chosen to avoid the formation of multi-layers on the surface as would be the case for difunctional and trifunctional silanes.

Procedure:

A 20% v/v 1H,1H,2H,2H-perfluorodecyldimethylchlorosilane (mF8H2) solution was prepared in perfluoro(methyldecalin). PET-APTES samples were attached to the lid of a Petri dish using double-sided tape. The lid was placed on top of the Petri dish that contained a small amount (˜1 mL) of mF8H2 solution so a ˜1 cm vertical gap was between the inverted samples and mF8H2 solution. The vapor deposition of mF8H2 onto the PET-APTES surface was allowed to proceed for about 5 minutes. The samples were then rinsed with copious amounts of hexane and dried under a stream of nitrogen gas.

After completion of the vapor deposition of mF₈H₂, a thickness increase of ˜0.3 nm was observed as discerned via ellipsometry (Table 3). No change in thickness was observed in virgin PET samples exposed to the mF8H2 vapor, indicating that APTES must be present on the PET surface for mF8H2 to attach to the surface. AFM imaging shows that there is not a significant increase in the surface roughness after vapor deposition of mF8H2 on PET-APTES surface (see Table 3 and FIGS. 11C and 11D).

TABLE 3

| Sample | Thickness (nm) | RMS (nm) |
|---|---|---|
| PET-APTES-Perfluorosilane | 0.2 | 0.5 |

The presence of fluorine in MF8H2 provides a distinct chemical signature since fluorine is not present in any of the other materials utilized in our study. As shown in FIG. 12, XPS spectra show a sharp signal at ˜685 eV, which corresponds to fluorine on the surface, for the control silica surface (black) and the ATPES treated PET (blue), but no signal is present for virgin PET (red). A ToF-SIMS imaging of the fluorine ion (F⁻) fragment for virgin PET and APTES-modified PET prior and post exposure to mF8H2 vapor is shown in FIG. 13. As shown in FIG. 13, there was no increase in the relative intensity F-ion between virgin PET and PET post-exposure to mF8H2 vapor (left column), which indicate that mF8H2 did not adhere at all to virgin PET surfaces. In contrast, there was a significant increase in F⁻ intensity when PET-APTES is exposed to mF8H2 vapor for 5 minutes (right column) indicating that mF8H2 adhered very well to APTES treated PET surfaces, probably via Si—O—Si linkages. Also, as shown in FIG. 13, the mF8H2 covers the area of the sample uniformly as deduced from the 100×100 μm² TOF-SIMS scan. This further confirms that PET has been uniformly amidated with APTES, since silanol moieties on the surface were found to be necessary for mF8H2 to react with the surface.

FIG. 14 shows a histogram of the pixel intensities from FIG. 13, to illustrate the increase in signal intensity from Tof-SIMS measurements.

### Example 5. Spin Coating a Thin Silicate Film onto PET

Procedure:

Silicate layers were deposited onto APTES-treated PET films using tetraethyl orthosilicate (TEOS) as the precursor via a sol-gel process. Tetraethyl orthosilicate (TEOS) was slowly added to 1:1 v/v mixture of ethanol and aqueous hydrochloric acid (1 M) while stirring. The solution was then diluted with ethanol until TEOS concentration was 1-3% v/v. Then, an equal volumetric amount of aq. sodium hydroxide (1 M) to that of aq. hydrochloric acid was slowly added to the mixture while stirring. Thin silicate films were spin-cast onto clean silicon wafers and APTES treated PET substrates. All silicate films were then left in air at room temperature and ambient relative humidity.

The silicate films had thickness values ranging from 10 to 40 nm as shown in Table 4. Fourier transform infrared—attenuated total reflectance (FTIR-ATR) spectrum of spin-cast silicate film (FIG. 15) shows most of the film is composed of Si—O—Si linkages (peak at ˜1100 cm⁻¹). However, the presence of —CH₂ and —CH₃ stretches below the 3000 cm¹ region indicate that not all ethoxy groups in TEOS were hydrolyzed.

TABLE 4

| Sample | Thickness (nm) | WCA (degrees) | RMS (nm) |
|---|---|---|---|
| Virgin PET | 12.68 ± 0.03 | ~75 | 0.2 |
| PET-1 hr. reaction | 0.52 ± 0.01 | ~48 | 0.5 |
| time with APTES | (top layer only) | | |
| Silicate layer on | 27.7 ± 0.1 | <10 | 2.5 |
| APTES-activated PET | (top layer only) | | |

Spin-cast films on both silicon wafer and PET-APTES substrates appear uniform and relatively smooth, as confirmed by AFM imaging (FIG. 16). Water contact angle measurements show that silicate films spin-cast onto PET-APTES substrate are fully wettable surfaces; water droplet spreads instantly across the entire surface.

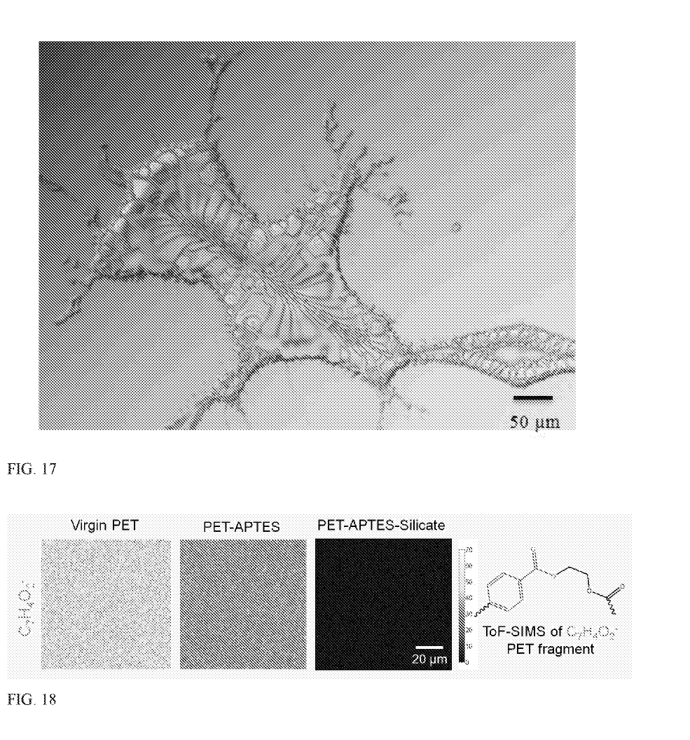

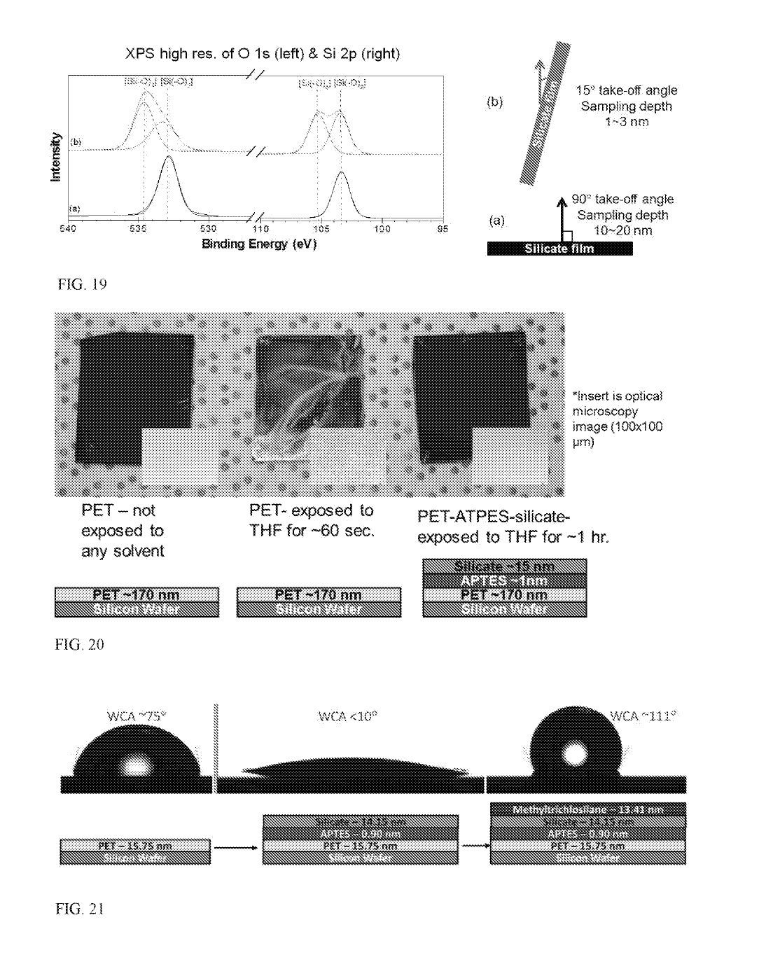

Silicate films spin-cast onto virgin PET delaminate during the casting procedure (FIG. 17), but not when spin-cast onto an APTES treated PET film. This indicates that APTES molecules present on PET surfaces act as anchoring points between PET and silicate films. ToF-SIMS images of C₇H₄O₂⁻ (m/z: 120.02) PET fragment show that PET is, initially, partially covered after APTES deposition (FIG. 18). Upon deposition of silicate layer, we observe no C₇H₄O₂⁻ (m/z: 120.02) PET fragments indicating that the PET film is fully covered by the silicate layer. This result is further corroborated by XPS spectra in FIG. 19, where the characteristic ester peaks in the O is and C is region disappear in the silicate coated PET-APTES substrate along with an increase in intensity of the Si 2p peak.

### Example 6. Solvent Resistance of APTES Treated PET Film Modified with Silicate Layer

PET surfaces can undergo solvent-induced crystallization when exposed to a variety of solvents, including toluene and THF. This behavior places a limit on the kind of reactions in which the surface modification of PET can be performed. Spin coating a thin silicate film onto the PET can dramatically improve the solvent resistance. For example, FIG. 20 shows a thin silicate layer (˜15 nm) was capable of significantly improving the solvent resistance of the modified PET film, as discerned via changes in topography and optical microscopy. FIG. 20 shows a 170 nm thick PET film (left) that has not been exposed to any solvent. The PET film in the middle has been exposed to THF for 60 seconds, which is enough to cause dramatic changes to the both the bulk properties of the film, evident as hazing, and the surface topography, as evidenced by the rough appearance of the 100×100 μm² optical microscopy insets. The film on the right has been treated with aqueous APTES, followed by a thin layer of spun cast glass, which after exposure to THF for over 1 hour shows no significant observable effects. This expands the choices of solvents that PET can be subjected to for further modification. Furthermore, the silicate layer has the potential to improve the gas barrier properties of polyesters and post functionalization of the surface.

### Example 7. Modifying the Hydrophilicity and Hydrophobicity of Spin-Coated PET

Using the spin-on-glass procedure, films can be modified to enhance either their hydrophilicity or their hydrophobicity. FIG. 21 shows water contact angles (WCA) for (left) a spun-cast layer of PET, (middle) a spun-cast layer of PET, treated with APTES, followed by a spun-cast layer of silicate, and (right) the same composite PET/ATPES/silicate layers subjected to solvent deposition of trimethylchlorosilane in toluene. Spin casting the silicate layer onto the PET dramatically decreased the WCA, thus making the surface hydrophilic. Alternately, solution deposition of trimethylchlorosilane forms a thin hydrophobic monolayer on the surface of the PET and increases the WCA, making the surface hydrophobic.

### Example 8. Evaluating Solvent Resistance and Transparency Upon Solvent Exposure of APTES-Treated PET Film Coated with a Silicate Film

APTES-treated PET film was dipped into an aqueous solution having 40% v/v sodium silicate and was withdrawn at a speed of 100 mm/min. The film was allowed to air-dry at room temperature at a relative humidity of ˜9% overnight. The resulting silicate film thickness was 10 μm. After curing, the films were placed in THF for various times.

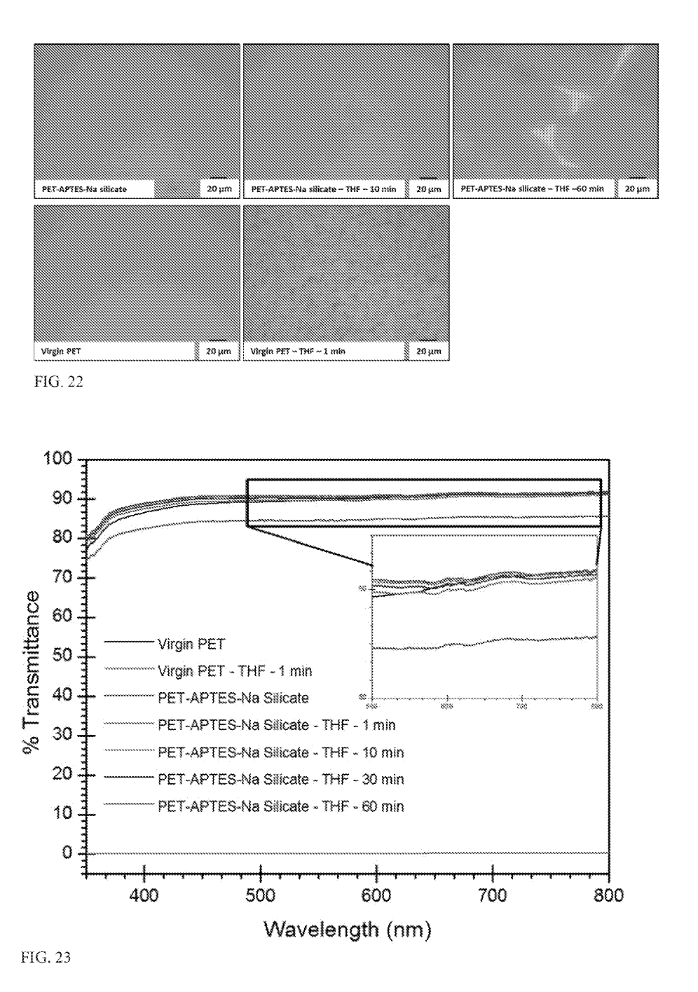

As shown in FIG. 22, the sodium silicate films remain visually intact up to 10 minute exposure to THF. After 1 hour, however, some cracks start to appear on the surface. These cracks continue to propagate the longer the film is left in THF solvent.

The percentage of light transmitted through the film (% T) using UV/Vis was measured to quantify how the transparency was maintained upon solvent exposure. As shown in FIG. 23, virgin PET film (250 μm thick) had a % T of ˜89% at 600 nm. Exposure of virgin PET film in THF for just ˜1 min, caused the % T to drop down to near zero at 600 nm. The sodium silicate coating largely prevented decreases in % T. The % T of PET coated with sodium silicate remains at about 89% even after 30 minutes of continued exposure to THF. After 1 hour, however, the % T did decrease to ˜85% due to the formation of cracks on the sodium silicate coating.

Various crosslinkers, such as tetraacetoxysilane and boric acid, can minimize crack formation and propagation on silicate films exposed to THF. Other organic solvents can also affect the morphology of silicate films. Toluene does not cause the formation of cracks up to 16 hours of exposure. Longer times are currently being investigated. This coating may reduce oxygen permeation through the polymer films.

PET surfaces have been reacted with 3-aminopropyltriethoxysilane in aqueous solutions, and the reaction is much slower in other solvents (alcohols, tetrahydrofuran, and toluene). Water is an attractive solvent as it is non-flammable, non-toxic, and inexpensive, and thus makes this process suitable for scale-up. The reaction conditions described in the examples creates relatively uniform ATPES monolayers. The formation of islands or cross-linked APTES aggregates is not observed either in AFM images or ToF-SIMS images. While PET was used in all experiments, the described procedure is applicable to other polyester films as well, since this process relies on an ester-to-amide reaction. Furthermore, the described procedure should also be applicable to polyester fibers.

The present disclosure demonstrates that APTES can act as an adhesion promoter between a polyester and a silicate layer, and that the silicate layer significantly improves the solvent resistance of the polymer. The gas permeability of the modified polymer may decrease as well. Finally, the composition of matter of the partially hydrolyzed tetraethyl orthosilicate is new and distinguishable from other, silicate layer-forming, precursor compositions.

The activation of PET with APTES followed by silicate film deposition can serve as a platform to endow the surface with various functionalities by taking advantage of excess hydroxyl moieties present on the surface. These surface functionalities include (but are not limited to) biocidal, anti-fouling, hydrophilic coatings for biomedical applications; biocidal and anti-fouling finishes for filtering applications; and hydrophobic surfaces for self-cleaning applications.

### 6. Exemplary Embodiments

For reasons of completeness, various aspects of the disclosure are set out in the following numbered clauses:

Clause 1. A surface-modified polymer composition, comprising: (a) a polymer; and (b) a multifunctional surface-modifier covalently bonded to the polymer; wherein the polymer is substantially free of solvent-induced crystallization or plasticization as measured by x-ray diffraction or atomic force microscopy.

Clause 2. The composition of clause 1, wherein the polymer is a polyester.

Clause 3. The composition of clause 1, wherein the polymer is polyethylene terephthalate.

Clause 4. The composition of clause 1, wherein the polymer is amorphous polyethylene terephthalate or biaxially oriented polyethylene terephthalate.

Clause 5. The composition of clause 1, wherein the multifunctional surface-modifier has formula:

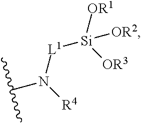

wherein R¹, R², and R³ are each independently selected from the group consisting of hydrogen optionally substituted C₁-C₆-alkyl, and optionally substituted aryl; R⁴ is hydrogen or C₁-C₆-alkyl; L¹ is C₁-C₁₀-alkylene.

Clause 6. The composition of clause 5, wherein R¹, R², and R³ are each ethyl.

Clause 7. The composition of clause 5, wherein R¹, R², and R³ are each hydrogen.

Clause 8. The composition of clause 5, wherein L¹ is C₃-alkylene and R⁴ is hydrogen.

Clause 9. A method of preparing a surface-modified polymer composition, comprising reacting a polymer with a multifunctional surface-modifier in aqueous solution.

Clause 10. The method of clause 9, wherein the polymer is a polyester.

Clause 11. The method of clause 9, wherein the polymer is polyethylene terephthalate.

Clause 12. The method of clause 9, wherein the multifunctional surface-modifier is an aminosiloxane.

Clause 13. The method of clause 9, wherein the multifunctional surface-modifier has formula:

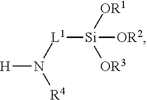

wherein R¹, R², and R³ are each independently selected from the group consisting of hydrogen optionally substituted C₁-C₆-alkyl, and optionally substituted aryl; R⁴ is hydrogen or C₁-C₆-alkyl; and L¹ is C₁-C₁₀-alkylene.

Clause 14. The method of clause 9, wherein the multifunctional surface-modifier is 3-aminopropyltriethyoxysilane (APTES), 3-aminopropyltrimethoxy silane (ATMS), 3-aminopropyltriisopropoxyoxysilane, or 3-aminopropyltributoxysilane.

Clause 15. The method of clause 9, wherein the concentration of the multifunctional surface-modifier in the aqueous solution is 0.5-2% v/v.

Clause 16. The method of clause 9, wherein the concentration of the multifunctional surface-modifier in the aqueous solution is 1% v/v or less.

Clause 17. The method of clause 9, wherein the reaction is complete within 3 hours or less, as measured by one or more of XPS, TOF-SIMS, and FT-IR.

Clause 1 8. The method of clause 9, wherein the reaction is complete within 1 hour or less.

Clause 19. The method of clause 9, wherein the reaction is conducted at ambient temperature or greater.

Clause 20. The method of clause 9, wherein the reaction conversion is greater in comparison to non-aqueous-based process.

Clause 21. The method of clause 9, wherein the reaction rate is faster in comparison to a non-aqueous-based process.

Clause 22. The method of clause 9, wherein the surface-modified polymer composition comprises a uniform topography, as measured by atomic force microscopy imaging.

Clause 23. The method of clause 9, wherein the surface-modified polymer composition comprises a surface uniformly covered with the multifunctional surface-modifier, as measured by time of flight secondary ion mass spectrometry.

Clause 24. The method of clause 9, wherein the surface-modified polymer composition comprises a modified surface having a thickness of about 0.7 nanometers, as measured by variable angle spectroscopic ellipsometry.

Clause 25. The method of clause 9, further comprising rinsing the reaction product with aqueous acid having a pH of about 4.

Clause 26. The method of clause 9, further comprising rinsing the reaction product with a mineral acid or carboxylic acid.

Clause 27. A method of modifying the surface of a polyester, comprising: preparing an aqueous solution of a multifunctional amine compound at a concentration of 0.5-2% v/v; mixing the aqueous solution; adding a polyester to the aqueous solution: and mixing the aqueous solution comprising the polyester and multifunctional amine to provide a surface-modified polyester.

Clause 28. The method of clause 27, further comprising isolating the surface-modified polyester from the aqueous solution and thereafter rinsing the surface-modified polyester.

Clause 29. The method of clause 28, further comprising drying the rinsed surface-modified polyester.

Clause 30. The method of clause 27, wherein the multifunctional surface-modifier has formula:

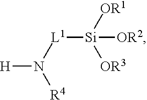

wherein R¹, R², and R³ are each independently selected from the group consisting of hydrogen optionally substituted C₁-C₆-alkyl, and optionally substituted aryl; R⁴ is hydrogen or C₁-C₆-alkyl; and L¹ is C₁-C₁₀-alkylene.

Clause 31. The method of clause 27, wherein the multifunctional amine is 3-aminopropyltriethyoxysilane (APTES), 3-aminopropyltrimethoxysilane (ATMS), 3-aminopropyltriisopropoxyoxysilane, or 3-aminopropyltributoxysilane.

Clause 32. A surface-modified polymer composition, comprising: (a) a polymer; (b) a multifunctional linker; and (c) a surface group; wherein the multifunctional linker is covalently bonded to the polymer and to the surface group, linking the surface group to the polymer; and wherein the polymer is substantially free of solvent-induced crystallization or plasticization.

Clause 33. The composition of clause 32, wherein the polymer is a polyester.

Clause 34. The composition of clause 32, wherein the polymer is polyethylene terephthalate.

Clause 35. The composition of clause 32, wherein the multifunctional linker is derived from a compound of formula:

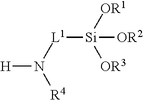

wherein R¹, R², and R³ are each independently selected from the group consisting of hydrogen, optionally substituted C₁-C₆-alkyl, and optionally substituted aryl; R⁴ is hydrogen or C₁-C₆-alkyl; and L¹ is C₁-C₁₀-alkylene.

Clause 36. The composition of clause 32, wherein the multifunctional linker is derived from 3-aminopropyltriethyoxysilane (APTES), 3-aminopropyltrimethoxysilane (ATMS), 3-aminopropyltriisopropoxyoxysilane, or 3-aminopropyltributoxysilane.

Clause 37. The composition of clause 32, wherein the surface group is a silicate or orthosilicate.

Clause 38. The composition of clause 32, wherein the surface group is derived from sodium silicate, tetramethyl orthosilicate, or tetraethyl orthosilicate.

Clause 39. The composition of clause 32, comprising groups of formula:

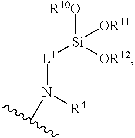

wherein R⁴ at each occurrence is independently hydrogen or C₁-C₆-alkyl; L¹ at each occurrence is independently selected from a C₁-C₁₀-alkylene; and R¹⁰, R¹¹, and R¹², at each occurrence, are each independently selected from the group consisting of hydrogen, optionally substituted C₁-C₆-alkyl, optionally substituted aryl, and a surface group, provided that at least one of R¹⁰, R¹¹, and R¹² is a surface group.

Clause 40. The composition of clause 39, wherein the composition has formula:

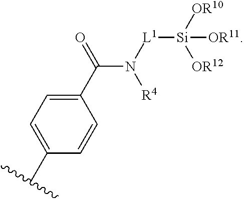

Clause 41. The composition of clause 39, wherein the composition has formula:

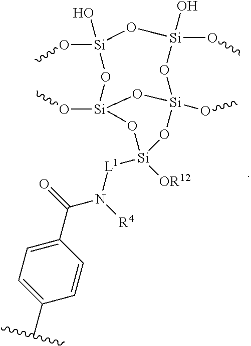

Clause 42. The composition of clause 39, wherein the composition has formula:

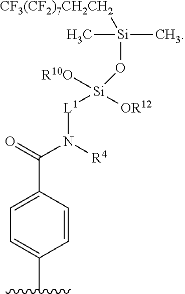

Clause 43. The composition of clause 32, wherein the surface group has a thickness within the range of 10 to 200 nm, as measured by variable angle ellipsometry.

Clause 44. The composition of clause 32, wherein the surface group has a thickness within the range of 10 nm to 20 μm, as measured by a thickness gauge.

Clause 45. The composition of clause 32, having one or more of the following properties: solvent-resistance, fouling-resistance, or scratch-resistance.

Clause 46. An article comprising the composition of clause 32, selected from the group consisting of a microchannel, a microfilter, a microinjector, a display device, a touch-screen, a flexible display, a packaging, a gas-impenetrable packaging, a biomedical device, an implant, a tissue scaffold, a medical suture, an anti-fouling device or coating, a filter, a biocidal device or coating, a hydrophobic coating, a hydrophilic coating, an anti-bacterial device or coating, a self-cleaning surface, an electronic device, a medical device, an article of clothing, a household product, a consumer product, a building material, a sewer device or coating, a food processing device, a ship or boat, a vessel hull, a paper manufacturing device, a cooling water system, a marine engineering system, an adhesive, insulation, and a computer.

Clause 47. A method of preparing a surface-modified polymer composition comprising: reacting a polymer with a multifunctional linker in aqueous solution to provide a first surface-modified polymer: hydrolyzing one or more functional groups of the first surface-modified polymer to provide a second surface-modified polymer; and reacting the second surface-modified polymer with a surface-modifier to provide a third surface-modified polymer.

Clause 48. The method of clause 47, wherein the polymer is a polyester.

Clause 49. The method of clause 47, wherein the polymer is polyethylene terephthalate.

Clause 50. The method of clause 47, wherein the multifunctional linker is 3-aminopropyltriethyoxysilane (APTES), 3-aminopropyltrimethoxysilane (ATMS), 3-aminopropyltriisopropoxyoxysilane, or 3-aminopropyl tributoxysilane.

Clause 51. The method of clause 47, wherein the first surface-modified polymer comprises groups of the formula:

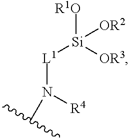

wherein R¹, R², and R³ are each independently selected from the group consisting of hydrogen, optionally substituted C₁-C₆-alkyl, and optionally substituted aryl; R⁴ is hydrogen or C₁-C₆-alkyl; and L¹ is C₁-C₁₀-alkylene.

Clause 52. The method of clause 47, wherein the second surface-modified polymer comprises groups of the formula:

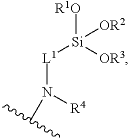

wherein R¹, R², and R³ are each independently selected from the group consisting of hydrogen, optionally substituted C₁-C₆-alkyl, and optionally substituted aryl, provided that at least one of R¹, R², and R³ is hydrogen; R⁴ is hydrogen or C₁-C₆-alkyl; and L¹ is C₁-C₁₀-alkylene.

Clause 53. The method of clause 47, wherein the surface-modifier is a silicate or orthosilicate.

Clause 54. The method of clause 47, wherein the surface-modifier is sodium silicate, tetramethyl orthosilicate, or tetraethyl orthosilicate.

Clause 55. The method of clause 47, wherein the surface-modifier is tetraethyl orthosilicate and is applied to the second surface-modified polymer by spin casting.

Clause 56. The method of clause 47, wherein the surface-modifier is sodium silicate and is applied to the second surface-modified polymer by dip coating.

Clause 57. The method of clause 47, wherein surface-modifier is applied to the second surface-modified polymer by a sol-gel process.

Clause 58. The method of clause 47, wherein the third surface-modified polymer comprises groups of the formula:

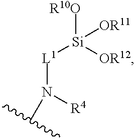

wherein R⁴ at each occurrence is independently hydrogen or C₁-C₆-alkyl; L¹ at each occurrence is independently selected from a C₁-C₁₀-alkylene; and R¹⁰, R¹¹, and R¹², at each occurrence, are each independently selected from the group consisting of hydrogen, optionally substituted C₁-C₆-alkyl, optionally substituted aryl, and a surface group, provided that at least one of R¹⁰, R¹¹, and R¹² is a surface group.

Clause 59. A method of preparing a surface-modified polyester composition, comprising: preparing a solution by mixing a water-soluble, multifunctional molecule containing at least one primary amine solution with water; combining the solution with a polyester to form a covalent bond between the primary amine and the polyester; isolating and rinsing the reacted polyester; preparing a silicate solution with a silicate or orthosilicate precursor; and depositing the silicate solution onto the reacted polyester so as to form a surface-modified polymer.

It is understood that the foregoing detailed description and accompanying examples are merely illustrative and are not to be taken as limitations upon the scope of the invention, which is defined solely by the appended claims and their equivalents.

What is claimed is:

1. A surface-modified polymer composition, comprising:
(a) a polymer;
(b) a multifunctional linker; and
(c) a surface group;
wherein the multifunctional linker is covalently bonded to the polymer and to the surface group, linking the surface group to the polymer; and
wherein the polymer is substantially free of solvent-induced crystallization or plasticization.

2. The composition of claim 1, wherein the polymer is a polyester.

3. The composition of claim 1, wherein the polymer is polyethylene terephthalate.

4. The composition of claim 1, wherein the multifunctional linker is derived from a compound of formula: 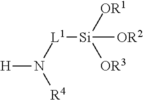
wherein R¹, R², and R³ are each independently selected from the group consisting of hydrogen, optionally substituted C₁-C₆-alkyl, and optionally substituted aryl; R⁴ is hydrogen or C₁-C₆-alkyl; and L¹ is C₁-C₁₀-alkylene.

5. The composition of claim 1, wherein the multifunctional linker is derived from 3-aminopropyltriethyoxysilane (APTES), 3-aminopropyltrimethoxysilane (ATMS), 3-aminopropyltriisopropoxyoxysilane, or 3-aminopropyltributoxysilane.

6. The composition of claim 1, wherein the surface group is a silicate or orthosilicate.

7. The composition of claim 1, wherein the surface group is derived from sodium silicate, tetramethyl orthosilicate, or tetraethyl orthosilicate.

8. The composition of claim 1, comprising groups of formula: 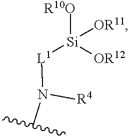
wherein R⁴ at each occurrence is independently hydrogen or C₁-C₆-alkyl; L¹ at each occurrence is independently selected from a C₁-C₁₀-alkylene; and R¹⁰, R¹¹, and R¹², at each occurrence, are each independently selected from the group consisting of hydrogen, optionally substituted C₁-C₆-alkyl, optionally substituted aryl, and a surface group, provided that at least one of R¹⁰, R¹¹, and R¹² is a surface group.

9. The composition of claim 8, wherein the composition has formula:

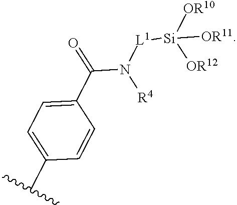

10. The composition of claim 8, wherein the composition has formula:

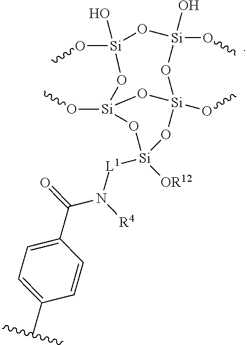

11. The composition of claim 8, wherein the composition has formula:

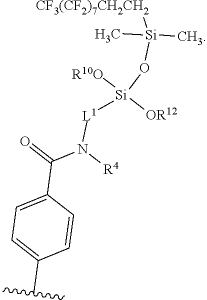

12. The composition of claim 1, wherein the surface group has a thickness within the range of 10 to 200 nm, as measured by variable angle ellipsometry.

13. The composition of claim 1, wherein the surface group has a thickness within the range of 10 nm to 20 μm, as measured by a thickness gauge.

14. The composition of claim 1, having one or more of the following properties: solvent-resistance, fouling-resistance, or scratch-resistance.

15. An article comprising the composition of claim 1, selected from the group consisting of a microchannel, a microfilter, a microinjector, a display device, a touch-screen, a flexible display, a packaging, a gas-impenetrable packaging, a biomedical device, an implant, a tissue scaffold, a medical suture, an anti-fouling device or coating, a filter, a biocidal device or coating, a hydrophobic coating, a hydrophilic coating, an anti-bacterial device or coating, a self-cleaning surface, an electronic device, a medical device, an article of clothing, a household product, a consumer product, a building material, a sewer device or coating, a food processing device, a ship or boat, a vessel hull, a paper manufacturing device, a cooling water system, a marine engineering system, an adhesive, insulation, and a computer.

16. A method of preparing a surface-modified polymer composition comprising:
reacting a polymer with a multifunctional linker in aqueous solution to provide a first surface-modified polymer;
hydrolyzing one or more functional groups of the first surface-modified polymer to provide a second surface-modified polymer; and
reacting the second surface-modified polymer with a surface-modifier to provide a third surface-modified polymer.

17. The method of claim 16, wherein the polymer is a polyester.

18. The method of claim 16, wherein the polymer is polyethylene terephthalate.

19. The method of claim 16, wherein the multifunctional linker is 3-aminopropyltriethyoxysilane (APTES), 3-aminopropyltrimethoxysilane (ATMS), 3-aminopropyltriisopropoxyoxysilane, or 3-aminopropyltributoxysilane.

20. The method of claim 16, wherein the first surface-modified polymer comprises groups of the formula: 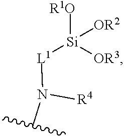
wherein R¹, R², and R³ are each independently selected from the group consisting of hydrogen, optionally substituted C₁-C₆-alkyl, and optionally substituted aryl; R⁴ is hydrogen or C₁-C₆-alkyl; and L¹ is C₁-C₁₀-alkylene.

21. The method of claim 16, wherein the second surface-modified polymer comprises groups of the formula: 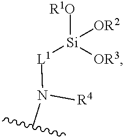
wherein R¹, R², and R³ are each independently selected from the group consisting of hydrogen, optionally substituted C₁-C₆-alkyl, and optionally substituted aryl, provided that at least one of R¹, R², and R³ is hydrogen; R⁴ is hydrogen or C₁-C₆-alkyl; and L¹ is C₁-C₁₀-alkylene.

22. The method of claim 16, wherein the surface-modifier is a silicate or orthosilicate.

23. The method of claim 16, wherein the surface-modifier is sodium silicate, tetramethyl orthosilicate, or tetraethyl orthosilicate.

24. The method of claim 16, wherein the surface-modifier is tetraethyl orthosilicate and is applied to the second surface-modified polymer by spin casting.

25. The method of claim 16, wherein the surface-modifier is sodium silicate and is applied to the second surface-modified polymer by dip coating.

26. The method of claim 16, wherein surface-modifier is applied to the second surface-modified polymer by a sol-gel process.

27. The method of claim 16, wherein the third surface-modified polymer comprises groups of the formula: 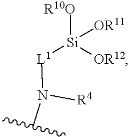
wherein R⁴ at each occurrence is independently hydrogen or C₁-C₆-alkyl; L¹ at each occurrence is independently selected from a C₁-C₁₀-alkylene; and R¹⁰, R¹¹, and R¹², at each occurrence, are each independently selected from the group consisting of hydrogen, optionally substituted C₁-C₆-alkyl, optionally substituted aryl, and a surface group, provided that at least one of R¹⁰, R¹¹, and R¹² is a surface group.

28. A method of preparing a surface-modified polyester composition, comprising:
preparing a solution by mixing a water-soluble, multifunctional molecule containing at least one primary amine solution with water;
combining the solution with a polyester to form a covalent bond between the primary amine and the polyester;
isolating and rinsing the reacted polyester;
preparing a silicate solution with a silicate or orthosilicate precursor; and
depositing the silicate solution onto the reacted polyester so as to form a surface-modified polymer.
